(19) United States
(12) Patent Application Publication
(10) Pub. No.: US 2009/0179833 A1
(43) Pub. Date: Jul. 16, 2009

(54) DISPLAY DEVICE AND ELECTRONIC APPLIANCE

(75) Inventor: Tatsuya HONDA, Isehara (JP)

Correspondence Address: NIXON PEABODY, LLP, 401 9TH STREET, NW, SUITE 900, WASHINGTON, DC, 20004-2128, US

(73) Assignee: SEMICONDUCTOR ENERGY LABORATORY CO., LTD., Atsugi-shi (JP)

(21) Appl. No.: 12/342,664

(22) Filed: Dec. 23, 2008

(30) Foreign Application Priority Data
Jan. 15, 2008 (JP) 2008-005329

(51) Int. Cl. G09G 3/30

(52) U.S. Cl. 345/76

(57) ABSTRACT

A display device having a light emission time necessary for performing impulse-type display which is suitable for motion image display comprises a resistor element including a first terminal and a second terminal, a transistor including a gate terminal which is electrically connected to a signal line, and a source terminal and a drain terminal, one of which is electrically connected to a power supply line, a capacitor element including a first terminal and a second terminal, one of which is electrically connected to one of the first terminal and the second terminal of the resistor element and the other of the source terminal and the drain terminal of the transistor, a light-emitting element including a first terminal and a second terminal, one of which is electrically connected the other of the first terminal and the second terminal of the resistor element.

### BACKGROUND OF THE INVENTION

1. Field of the Invention

The present invention relates to a display device. Further, the present invention relates to an electronic appliance having the display device in a display portion.

2. Description of the Related Art

In recent years, display devices such as an active matrix electroluminescent display device (hereinafter called an EL display device) perform so-called hold-type display, that is, a display method by which luminescence is held for one frame period (for example, Patent Document 1: Japanese Published Patent Application No. H8-54836).

The hold-type display easily causes a problem (motion blur) that when a part of a display image moves, the moving part appears to leave a trace or when the whole display image moves, the whole display image seems blurred. For this reason, it is said that so-called impulse-type display, such as a CRT display, in which a light-emitting element in a pixel emits light once in one frame period and then luminance of the emitted light decreases is suitable for motion image display.

However, a light-emitting element used at present for an EL display device or the like emits light for a shorter time than a phosphor used for a display device such as a CRT display. Therefore, it is difficult for an EL display device using a light-emitting element to perform impulse-type display for a light emission time which corresponds to that of a display device such as a CRT display. In general, a phosphor used for a CRT display has a light emission time of about 1 msec; on the other hand, a light-emitting element used for an EL display device has a light emission time of about several microseconds.

For example, a method in which a capacitor element is provided additionally in order to extend the light emission time in a display device having a light-emitting element, such as the aforementioned EL display device, has been disclosed (For example, Patent Document 1 Japanese Published Patent Application No. H8-54836).

### SUMMARY OF THE INVENTION

However, in the case of a display device having a light-emitting element such as the aforementioned EL display device, a capacitor element with large electrostatic capacitance is needed in order to assure a light emission time necessary for performing impulse-type display, resulting in that the electrode area of the capacitor element increases. The use of such a capacitor element in manufacturing a display device causes decrease in aperture ratio of the display device. Moreover, it takes longer time to accumulate electric charge in the capacitor element, so that a problem occurs in that a predetermined amount of electric charge cannot be accumulated in the capacitor element within a writing period. When enough electric charge is not accumulated in the capacitor element, voltage applied to the light-emitting element is lower than a predetermined voltage; therefore, light emission luminance of the EL display device is lower than a predetermined luminance of that. The problem in that the predetermined amount of electric charge cannot be accumulated in the capacitor element within the writing period becomes more remarkable as the panel size of the display device increases, because pixel pitch, wiring resistance, and the like also increase.

In view of the above problems, it is an object of the present invention to provide a light emission time necessary for performing impulse-type display which is suitable for motion image display.

An aspect shown as an example is a display device including a scanning line, a signal line, a power supply line, and a pixel. The pixel includes a resistor element; a capacitor element including a first terminal and a second terminal; a first transistor including a gate terminal which is electrically connected to the scanning line and a source terminal and a drain terminal, one of which is electrically connected to the signal line; a second transistor including a gate terminal which is connected to the other of the source terminal and the drain terminal of the first transistor, a source terminal and a drain terminal, one of which is electrically connected to the power supply line and the other of which is electrically connected to the first terminal of the capacitor element; and a light-emitting element including a first terminal and a second terminal, wherein the first terminal of the light-emitting element is electrically connected to the first terminal of the capacitor element via the resistor element.

Another aspect is a display device including a scanning line, a signal line, a power supply line, and a pixel. The pixel includes a resistor element; a capacitor element including a first terminal and a second terminal; a first transistor including a gate terminal which is electrically connected to the scanning line, a source terminal and a drain terminal, one of which is electrically connected to the signal line; a second transistor including a gate terminal which is connected to the other of the source terminal and the drain terminal of the first transistor, a source terminal and a drain terminal, one of which is electrically connected to the power supply line, and the other of which is electrically connected to the first terminal of the capacitor element; a third transistor including a gate terminal which is connected to the other of the source terminal and the drain terminal of the first transistor, a source terminal and a drain terminal, one of which is electrically connected to the power supply line, and the other of which is electrically connected to the first terminal of the capacitor element via the resistor element; and a light-emitting element including a first terminal and a second terminal, wherein the first terminal of the light-emitting element is electrically connected to the other of the source terminal and the drain terminal of the third transistor.

Note that the second transistor and the third transistor can have the same conductivity type.

Another aspect is a display device including a scanning line, a signal line, a power supply line, and a pixel. The pixel includes a resistor element; a capacitor element including a first terminal and a second terminal; a transistor including a gate terminal which is electrically connected to the scanning line, a source terminal and a drain terminal, one of which is electrically connected to the signal line; and a light-emitting element including a first terminal and a second terminal, wherein the first terminal of the light-emitting element is electrically connected via the resistor element to the first terminal of the capacitor element and to the other of the source terminal and the drain terminal of the transistor.

Another aspect is a display device including a scanning line, a signal line, a power supply line, and a pixel. The pixel includes a resistor element; a capacitor element including a first terminal and a second terminal; a light-emitting element including a first terminal and a second terminal; a first transistor including a gate terminal which is electrically connected to the scanning line, a source terminal and a drain terminal, one of which is electrically connected to the signal line; a second transistor including a gate terminal which is electrically connected to the other of the source terminal and the drain terminal of the first transistor, a source terminal and a drain terminal, one of which is electrically connected to the power supply line and the other of which is electrically connected to the first terminal of the light-emitting element; and a third transistor including a gate terminal which is electrically connected to the scanning line, a source terminal and a drain terminal, one of which is electrically connected via the resistor element to the other of the source terminal and the drain terminal of the first transistor and to the first terminal of the capacitor element, and the other of which is electrically connected to the second terminal of the capacitor element.

Note that the first transistor and the third transistor can have different conductivity types from each other.

Note that the time for accumulating electric charge in the capacitor element can be set to be shorter than one horizontal period of the pixel.

Further, the capacitor element includes a first electrode, a second electrode, and a dielectric layer sandwiched between the first electrode and the second electrode. The dielectric layer can be formed of a material with a relative dielectric constant of 8 or more.

The light emission time of the light-emitting element can be set to be shorter than one frame period.

An aspect of the present invention is an electronic appliance whose display portion has any of the above display devices of the present invention.

Note that a transistor in this document (the specification, the claims, the drawings, or the like) has at least three terminals: a gate terminal, a source terminal, and a drain terminal. A gate terminal refers to a gate electrode portion (including a region serving as a gate, a conductive layer, a wiring, and the like) or part of a portion which is electrically connected to the gate electrode. A source terminal refers to a source electrode portion (including a region serving as a source, a conductive layer, a wiring, and the like) or part of a portion which is electrically connected to the source electrode. A drain terminal refers to a drain electrode portion (including a region serving as a drain, a conductive layer, a wiring, and the like) or part of a portion which is electrically connected to the drain electrode.

Since the source terminal and the drain terminal of the transistor in this document (the specification, the claims, the drawings, or the like) change depending on the structure, the operating conditions, or the like of the transistor, it is difficult to define which terminal is the source terminal or the drain terminal. Therefore, in this document (the specification, the claims, the drawings, or the like), one terminal which is selected as appropriate from a source terminal and a drain terminal is referred to as one of the source terminal and the drain terminal, whereas the other terminal is referred to as the other of the source terminal and the drain terminal.

Further, in this document (the specification, the claims, the drawings, or the like), a capacitor element includes at least a first electrode, a second electrode, and a dielectric layer sandwiched between the first electrode and the second electrode. Part or the whole of the first electrode is referred to as one terminal and part or the whole of the second electrode is referred to as the other terminal. However, the structure is not limited to the above and another structure can also be applied.

Furthermore, in this document (the specification, the claims, the drawings, or the like), a light-emitting element includes at least a first electrode, a second electrode, and an electroluminescent layer sandwiched between the first electrode and the second electrode. Part or the whole of the first electrode is referred to as one terminal and part or the whole of the second electrode is referred to as the other terminal. However, the structure is not limited to the above and another structure can also be applied.

According the present invention, the light emission time necessary for performing impulse-type display which is suitable for motion image display can be assured.

### BRIEF DESCRIPTION OF THE DRAWINGS

FIG. 1 illustrates a structure of a pixel in Embodiment Mode 1.

FIG. 2 is a timing chart illustrating an operation of the pixel in Embodiment Mode 1.

FIG. 3 illustrates a structure of a pixel in Embodiment Mode 2.

FIG. 4 illustrates a structure of a pixel in Embodiment Mode 3.

FIG. 5 illustrates a structure of a pixel in Embodiment Mode 4.

FIG. 6 illustrates structures of transistors each of which can be applied to a pixel in Embodiment Mode 5.

FIGS. 7A to 7E illustrate manufacturing methods of the transistors each of which can be applied to the pixel in Embodiment Mode 5.

FIGS. 8A to 8C illustrate manufacturing methods of transistors each of which can be applied to the pixel in Embodiment Mode 5.

FIGS. 9A to 9D illustrate manufacturing methods of the transistors each of which can be applied to the pixel in Embodiment Mode 5.

FIG. 10 is a block diagram illustrating a structure of a display device in Embodiment Mode 6.

FIGS. 11A and 11B are block diagrams illustrating structures of driver circuits of a display device in Embodiment Mode 6.

FIGS. 12A to 12H illustrate examples of electronic appliances whose display portions include display devices in Embodiment Mode 7.

FIGS. 13A to 13C illustrate examples of electronic appliances whose display portions include display devices in Embodiment Mode 7.

### DETAILED DESCRIPTION OF THE INVENTION

Embodiment modes will hereinafter be described with reference to the drawings. However, it is easily understood by those skilled in the art that the modes and details herein disclosed can be modified in a variety of ways without departing from the scope and the spirit of the present invention. Therefore, the present invention should not be construed as being limited to the following description of the embodiment modes.

### Embodiment Mode 1

This embodiment mode describes one mode of display devices.

The display device as one mode in the present invention includes a scanning line, a signal line, a power supply line, and a pixel. A specific structure thereof is described below.

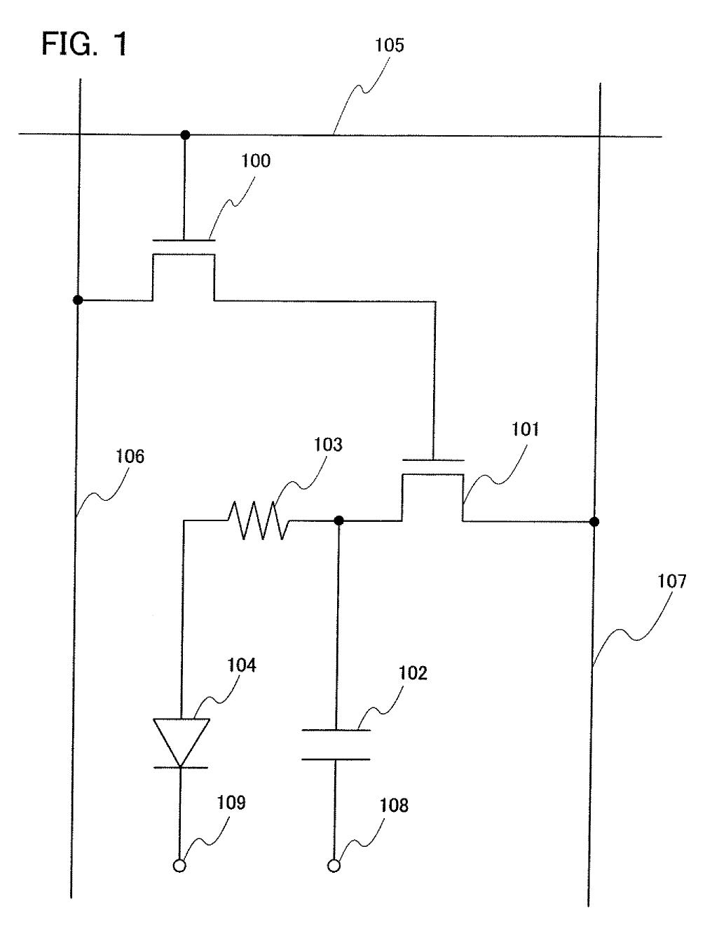

First, a structure of the pixel in the display device of this embodiment mode is described with reference to FIG. 1. FIG. 1 shows a circuit diagram illustrating the structure of the pixel in the display device of this embodiment mode.

As illustrated in FIG. 1, the pixel in the display device of this embodiment mode has a first transistor 100, a second transistor 101, a capacitor element 102, a resistor element 103, and a light-emitting element 104.

A gate terminal of the first transistor 100 is electrically connected to a scanning line 105, and one of a source terminal and a drain terminal of the first transistor 100 is electrically connected to a signal line 106. The first transistor 100 has a function as a switching transistor and is turned on or off depending on whether a potential difference between a potential of the gate terminal, which is determined by an input signal through the scanning line 105, and a potential of the source terminal, that is, voltage (hereinafter called Vgs) applied between the gate terminal and the source terminal is higher or lower than the threshold voltage (hereinafter called Vth) of the transistor. When the first transistor 100 is on, a signal potential of the signal line 106 is applied to a gate terminal of the second transistor 101 via the first transistor 100.

The gate terminal of the second transistor 101 is connected to the other of the source terminal and the drain terminal of the first transistor 100, and one of a source terminal and a drain terminal of the second transistor 101 is electrically connected to a power supply line 107. The second transistor 101 has a function as a driver transistor for controlling the light-emitting element 104 and is turned on or off depending on whether Vgs is higher or lower than Vth. When the second transistor 101 is on, a potential of a certain value can be applied to the light-emitting element 104; therefore, decrease or variation in luminance can be suppressed. Therefore, even a display device with a panel size of, for example, 5 inches or more can employ the pixel structure of the display device of this embodiment mode.

Note that each of the first transistor 100 and the second transistor 101 can be, for example, a bottom gate transistor or a top gate transistor. Alternatively, an n-channel transistor or a p-channel transistor can be used. Further alternatively, a multigate transistor having a plurality of gate terminals can be used as the first transistor 100. With the use of the multigate transistor, off-current can be reduced. Other than the multigate transistor, a structure including a plurality of transistors or the like can be employed.

One terminal of the capacitor element 102 is electrically connected to the other of the source terminal and the drain terminal of the second transistor 101. The capacitor element 102 has a function as an auxiliary capacitor for adjusting the light emission time of the light-emitting element 104 in the pixel and also has function for temporally retaining electric charge accumulated in accordance with the potential applied from the power supply line 107 to the light-emitting element 104. When the second transistor 101 is on, a potential of a certain value is applied from the power supply line 107 to the one terminal of the capacitor element 102 via the second transistor 101 and electric charge corresponding to the difference between the potentials applied to the one terminal and the other terminal of the capacitor element 102 is accumulated in the capacitor element 102. The other terminal of the capacitor element 102 is electrically connected to a first potential supply terminal 108. A ground potential or a potential of a predetermined value is applied to the capacitor element 102 via the first potential supply terminal 108.

At this time, a capacitance of the capacitor element 102 is desirably set so that electric charge can be accumulated within a predetermined data writing period. The capacitor element 102 can have a structure in which a dielectric layer is provided between two electrodes, and the dielectric layer can be formed using, for example, a silicon oxide film such as SiON, or the like. The dielectric layer can be formed of a material with a relative dielectric constant of 8 or more. For example, a Hf-based material (such as HfO₂, HfSiON, HfRu, HfLiaO, or HfAlON), a Y-based material (such as Y₂O₃, Y₄Al₂O₉, Y₄Al₂O₉, Y₃Al₅O₁₂, or YAlO), a Zr-based material (such as ZrO₂), a La-based material (such as La₂O₃), or the like can be used. When the material with high relative dielectric constant is used for the dielectric layer, the capacitance of the capacitor element 102 can be increased; therefore, the electrode area of the capacitor 102 element can be further decreased.

The resistor element 103 has a function for controlling the light emission time of the light-emitting element 104. By the addition of the resistor element 103, capacitance of a capacitor element which is necessary for performing impulse-type display can be decreased. The resistor element 103 can be formed using, for example, a semiconductor material; however, another material can also be applied. In this case, the resistance of the resistor element 103 and the capacitance of the capacitor element 102 are desirably set so that the electric charge relaxation time obtained by multiplying the resistance and the capacitance corresponds to a light emission time which is necessary for performing impulse-type display.

One terminal of the light-emitting element 104 is electrically connected to the one terminal of the capacitor element 102 via the resistor 103, and the other terminal of the light-emitting element 104 is electrically connected to a second potential supply terminal 109. A ground potential or a potential of a certain value is applied to the light-emitting element 104 via the second potential supply terminal 109. When the second transistor 101 is on, a potential of a predetermined value is applied from the power supply line 107 to the one terminal of the light-emitting element 104 via the second transistor 101 and current flows in accordance with the difference between the potentials applied to the one terminal and the other terminal of the light-emitting element 104, whereby the light-emitting element 104 emits light. The luminance of the light-emitting element 104 changes depending on the amount of current flowing to the light-emitting element 104.

The light-emitting element 104 can have a structure in which, for example, an electroluminescent layer is provided between two electrodes. For example, an organic material such as anthracene, an inorganic material such as ZnO, MgₓZ₁₋ₓO, ZnS, ZnTe, or CdS, or the like can be used for the electroluminescent layer.

Next, a display operation of the pixel in the display device of this embodiment mode is described. Note that, in this embodiment mode, the case of operating the pixel by current drive is described as one example.

In the case of performing display in a predetermined pixel, the display time consist of a horizontal period in which display data is written to the pixel and an electric charge relaxation period in which light emission of the light-emitting element continues even after the data writing. First, in a horizontal period, a scanning signal (a potential) is input to the gate terminal of the first transistor 100 via the scanning line 105 selected for writing display data to the pixel and the first transistor is turned on in accordance with the applied potential of the gate terminal of the first transistor 100. Then, a data signal (a potential) is input from the signal line 106 to the gate terminal of the second transistor 101 via the first transistor 100.

Then, the second transistor 101 is turned on in accordance with the potential of the gate terminal of the second transistor 101 and a potential of a predetermined value (here, a potential of the power supply) is applied from the power supply line 107 to the one terminal of the capacitor element 102 and the one terminal of the light-emitting element 104 via the second transistor 101. Electric charge corresponding to voltage applied between the one terminal and the other terminal of the capacitor element 102 is accumulated in the capacitor element 102, and current corresponding to the voltage applied between the one terminal and the other terminal of the light-emitting element 104 flows to the light-emitting element 104. The light-emitting element 104 emits light at luminance corresponding to the amount of the flowing current and thus performs display Here, the other terminal of the capacitor element 102 and the other terminal of the light-emitting element 104 each have a ground potential.

The display data writing is completed in this manner, and a scanning line in the next row or the next pixel is selected for writing display data to the next pixel. After that, the first transistor 100 in the pixel on which the display operation has been performed is turned off and the second transistor 101 is also turned off, and an electric charge relaxation starts.

At this time, the electric charge accumulated in the capacitor element 102 is released to the light-emitting element 104, and the light-emitting element 104 emits light and maintains its display state only while the electric charge accumulated in the capacitor element 102 is discharged.

Here, when T_{L} denotes a light emission time from turning on the second transistor 101 until the electric charge accumulated in the capacitor element 102 is discharged up to the light-emitting element 104 by turning off the second transistor 101, T_{L} can be expressed as the sum of one horizontal period (data writing period of one line pixels in the case of line sequential driving) and the electric charge relaxation time τ (period of time in which electric charge accumulated in a capacitor (here, the capacitor element 102) is discharged to a light-emitting element (here, the light-emitting element 104) by turning off a transistor (here, the second transistor 101)), that is, T_{L} can be expressed as T_{L}=1 horizontal period+τ. Moreover, τ can be expressed as τ=Ca×(R_{EL}+r) (this formula is hereinafter referred to as Formula 1) where Ca is the capacitance of the capacitor element 102, R_{EL} is the resistance of the light-emitting element 104, and r is the resistance of the resistor 103. In contrast, a time τₐ which is necessary for the capacitor element to accumulate electric charge when the second transistor 101 is on can be expressed as τₐ=Ca×Rₜ (this formula is hereinafter referred to as Formula 2) where Rₜ is the resistance of the transistor which is on. As is clear from this formula, when the capacitance Ca of the capacitor element 102 is increased in order to extend the electric charge relaxation time, it takes longer time to accumulate electric charge in the capacitor element. Therefore, the capacitor element desirably has a capacitance so that electric charge can be accumulated within a predetermined writing period.

As is clear from Formula 1, by using the structure in which the other of the source terminal and the drain terminal of the second transistor 101 is electrically connected to the capacitor element 102 and the other of the source terminal and the drain terminal of the second transistor 101 is electrically connected to the light-emitting element 104 via the resistor 103, the relaxation time τ can be extended by increasing the resistance r of the resistor element 103 even though the capacitance of the capacitor element 102 is small. Thus, the time for accumulating electric charge in the capacitor element 102 can be shortened, so that a display data can be written to a pixel within a predetermined writing period. Moreover, in the horizontal period in which the second transistor 101 is on, a power supply potential can be applied to the one terminal of the capacitor element 102 not via the resistor element 103; therefore, drop in voltage applied to the light-emitting element 104 due to the resistor element 103 can be suppressed. Therefore, by the addition of the resistor element 103, the electrode area of the capacitor element 102 can be minimized and the aperture ratio of the display device can be increased. Moreover, a light emission time necessary for performing impulse-type display can be obtained.

The potential of the power supply line 107 at this time is preferably set higher than the potential applied to the one terminal of the light-emitting element 104 in consideration of drop in voltage due to the resistance of the resistor element 103. The value of a potential Va which is added to the potential applied to the one terminal of the light-emitting element 104 can be expressed as Va=I_{EL}×r (this formula is hereinafter referred to as Formula 3) where I_{EL} is the current flowing in the light-emitting element 104 by the release of electric charge from the capacitor element 102. When the sum of Va and the predetermined potential applied to the one terminal of the light-emitting element 104 is set as the potential of the power supply line 107, the light-emitting element 104 can emit light at desired luminance to perform display even though voltage drop occurs due to the resistor element 103.

The time for accumulating electric charge in the capacitor element 102 is desirably shorter than one horizontal period. When the electric charge is accumulated within one horizontal period, the light-emitting element can emit light at desired luminance.

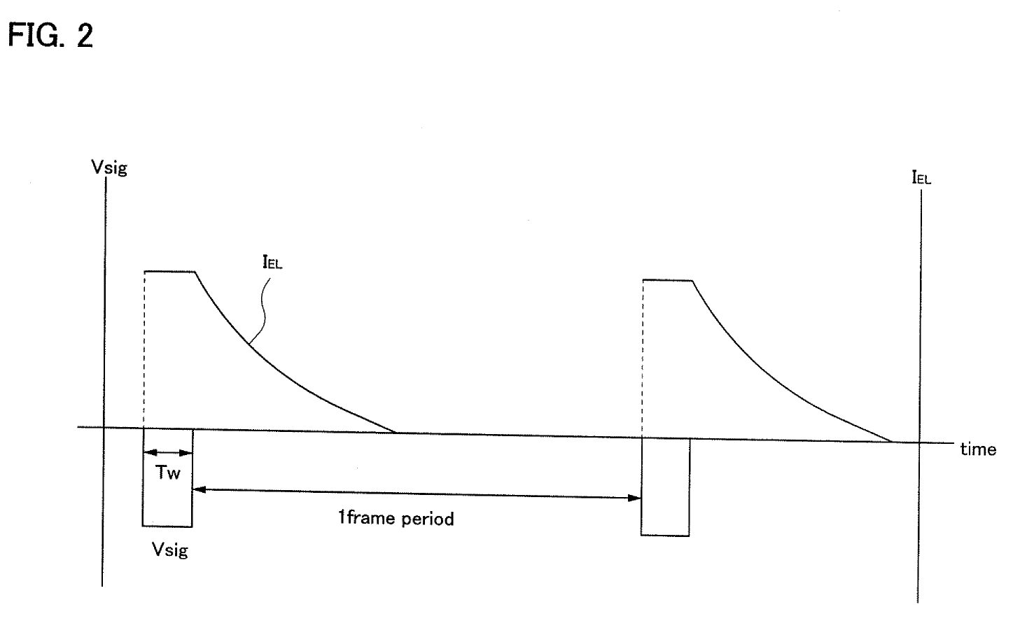

Next, an operation of the pixel of this embodiment mode will be described with reference to FIG. 2. FIG. 2 is a timing chart of driving the pixel of this embodiment mode. In the timing chart of FIG. 2, the second transistor 101 is a P-channel transistor and the second transistor 101 is turned on when the signal potential of the signal line 106 is negative.

In FIG. 2, Vsig represents the signal potential of the signal line 106, I_{EL} represents the current flowing to the light-emitting element 104, and Tw represents a data writing period. When the capacitor element 102 is not provided, the light-emitting element 104 emits light only in the writing period Tw; however, by the addition of the capacitor element 102, the time for which current flows to the light-emitting element 104 is extended, so that the light emission time can be extended as shown in FIG. 2.

In this manner, a light emission time necessary for performing impulse-type display which is suitable for motion image display can be obtained. Therefore, motion image display with less afterimages can be performed.

### Embodiment Mode 2

This embodiment mode describes another structure of a pixel in a display device.

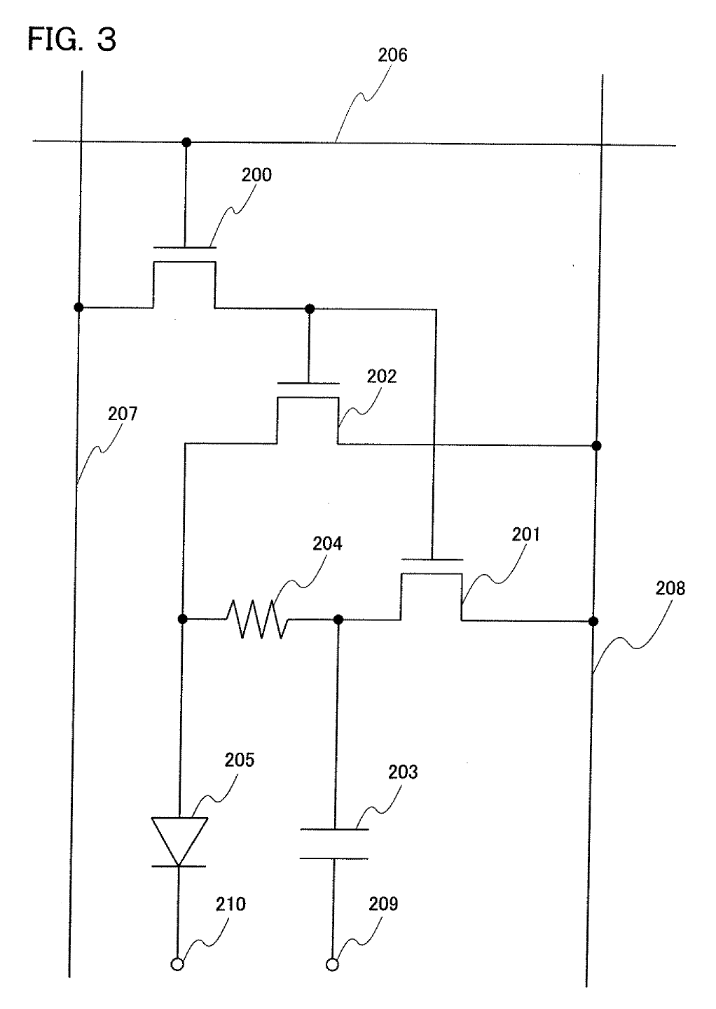

First, a structure of a pixel in a display device of this embodiment mode is described with reference to FIG. 3. FIG. 3 shows a circuit diagram illustrating the structure of the pixel in the display device of this embodiment mode.

As illustrated in FIG. 3, the pixel in the display device of this embodiment mode includes a first transistor 200, a second transistor 201, a third transistor 202, a capacitor element 203, a resistor element 204, and a light-emitting element 205.

A gate terminal of the first transistor 200 is electrically connected to a scanning line 206 provided in the display device, and one of a source terminal and a drain terminal of the first transistor 200 is electrically connected to a signal line 207 provided in the display device. The first transistor 200 has a function as a switching transistor and is turned on or off depending on whether Vgs applied to the first transistor 200 is higher or lower than Vth of the first transistor 200. When the first transistor 200 is on, a signal potential of the signal line 207 is applied to gate terminals of the second transistor 201 and the third transistor 202 via the first transistor 200.

The gate terminal of the second transistor 201 is connected to the other of the source terminal and the drain terminal of the first transistor 200 and one of a source terminal and a drain terminal of the second transistor 201 is electrically connected to a power supply line 208 provided in the display device. The second transistor 201 has a function for selecting whether to give electric charge to one terminal of the capacitor element 203 and is turned on or off depending on whether Vgs applied to second transistor 201 is higher or lower than Vth of the second transistor 201.

The gate terminal of the third transistor 202 is connected to the other of the source terminal and the drain terminal of the first transistor 200 and one of a source terminal and a drain terminal of the third transistor 202 is electrically connected to the power supply line 208. The third transistor 202 has a function for controlling the light-emitting element 205 and is turned on or off depending on whether Vgs applied to the third transistor 202 is higher or lower than Vth of the third transistor 202.

When one of the source terminal and the drain terminal of the second transistor 201 and one of the source terminal and the drain terminal of the third transistor 202 are electrically connected to the power supply line 208, a potential of a predetermined value can be applied to the one of the source terminal and the drain terminal of the second transistor 201 and the one of the source terminal and the drain terminal of the third transistor 202 via the power supply line 208, and a potential of a certain value can be applied to the light-emitting element 205. Therefore, decrease or variation in luminance can be suppressed. Accordingly, the pixel structure of the display device in this embodiment mode can easily be employed to even a display device with a panel size of, for example, 5 inches or more.

The second transistor 201 and the third transistor 202 desirably have the same conductivity type (p type or n type). By having the same conductivity type, the both transistors can be turned on or off in synchronization with each other.

As the first transistor 200 to the third transistor 202, for example, transistors which can be used as the first transistor 100 and the second transistor 101 in Embodiment Mode 1, or the like can be used.

The one terminal of the capacitor element 203 is electrically connected to the other of the source terminal and the drain terminal of the second transistor 201 and the other terminal of the capacitor element 203 is electrically connected to a first potential supply terminal 209. A ground potential or a potential of a predetermined value is applied to the capacitor element 203 via the first potential supply terminal 209. The capacitor element 203 has a function as an auxiliary capacitor for adjusting the light emission time of the light-emitting element 205 in the pixel. When the second transistor 201 is on, a potential of a predetermined value is applied from the power supply line 208 to the one terminal of the capacitor element 203 via the second transistor 201. Thus, electric charge corresponding to the difference between the potentials applied to the one terminal and the other terminal of the capacitor element 203 is accumulated in the capacitor element 203.

The capacitor element 203 at this time desirably has a capacitance so that electric charge can be accumulated within the time for writing display data to the pixel. The capacitor element 203 can be formed using, for example, the structure, the material, and the like which can be employed to the capacitor element 102 in Embodiment Mode 1.

The resistor element 204 has a function for adjusting the light emission time of the light-emitting element 205. By the addition of the resistor element, the capacitance of the capacitor element 203 which is necessary for performing impulse-type display can be decreased. The resistor element 204 can be formed using, for example, the structure, the material, and the like which can be employed to the resistor element 103 in Embodiment Mode 1. In this case, the resistance of the resistor element 204 and the capacitance of the capacitor element 203 are desirably set so that the electric charge relaxation time obtained by multiplying the resistance and the capacitance is equal to the light emission time necessary for performing impulse-type display.

One terminal of the light-emitting element 205 is electrically connected to the one terminal of the capacitor element 203 via the resistor 204 and is electrically connected to the other of the source terminal and the drain terminal of the third transistor 202. The other terminal of the light-emitting element 205 is electrically connected to a second potential supply terminal 210. A ground potential or a potential of a predetermined value is given to the light-emitting element 205 via the second potential supply terminal 210. When the second transistor 201 is on, a potential of a predetermined value is applied from the power supply line 208 to the one terminal of the light-emitting element 205 via the second transistor 201 so that voltage is applied between the one terminal and the other terminal of the light-emitting element 205. Then, current which corresponds to the applied voltage to the light-emitting element 205 flows to the light-emitting element 205, whereby the light-emitting element 205 emits light. The luminance of the light-emitting element 205 changes depending on the amount of current flowing to the light-emitting element 205. The light-emitting element 205 can be formed using, for example, the structure, the material, and the like which can be employed to the light-emitting element 104 in Embodiment Mode 1.

Next, a display operation of the pixel in the display device of this embodiment mode is described.

In the case of performing display in a predetermined pixel, a scanning signal (a potential) is input to the gate terminal of the first transistor 200 via the scanning line 206 selected for writing display data to the pixel, and the first transistor 200 is turned on in accordance with the potential applied to the gate terminal of the first transistor 200. Then, a data signal (a potential) is input from the signal line 207 to the gate terminals of the second transistor 201 and the third transistor 202 via the first transistor 200.

Then, the second transistor 201 and the third transistor 202 are turned on in accordance with the potential of the gate terminals of the second transistor 201 and the third transistor 202, so that a potential of a predetermined value (here, a positive potential of the power supply) is applied from the power supply line 208 to the one terminal of the capacitor element 203 and the one terminal of the light-emitting element 205 via the second transistor 201 and potential of the power supply line is applied to the one terminal of the light-emitting element 205 via the third transistor 202. At this time, a negative potential in which the amount of drop in voltage applied to the light-emitting element 205 due to the resistor element 204 is considered is desirably applied to the other terminal of the capacitor element 203. The negative potential corresponding to the amount of drop in voltage applied to the light-emitting element 205 due to the resistor element 204 is applied to the other terminal of the capacitor element 203; thus, the drop in voltage applied to the light-emitting element 205 due to the resistor 204, which generates at the electric charge relaxation time when the transistors 201 and 202 are off, can be compensated. In the capacitor element 203, the electric charge corresponding to the difference between the potentials applied to the one terminal and the other terminal thereof is accumulated; in the light-emitting element 205, the current corresponding to the potential difference applied between the one terminal and the other terminal thereof flows. The light-emitting element 205 emits light at luminance corresponding to the amount of the flowing current and thus performs display. Here, a ground potential is applied to the other terminal of the light-emitting element 205.

The display data writing is completed in this manner, and a scanning line in the next row or the next pixel is selected for writing a display data to the next pixel. Then, the first transistor 200 of the pixel after the display operation has been performed is turned off and the second transistor 201 and the third transistor 202 are also turned off.

At this time, the electric charge accumulated in the capacitor element 203 is released to the light-emitting element 205 via the resistor element 204. The voltage obtained by subtracting the amount of voltage drop due to the resistor element 204 from the voltage applied to the capacitor element 203 is applied to the light-emitting element 205, and the light emission continues only during the electric charge relaxation time.

The electric charge relaxation time τ of the light-emitting element 205 at this time can be represented by Formula 1 shown in Embodiment Mode 1.

In this manner, the other of the source terminal and the drain terminal of the second transistor 201 is electrically connected to the capacitor element 203, the other of the source terminal and the drain terminal of the third transistor 202 is electrically connected to the capacitor element 203 via the resistor element 204, and the other of the source terminal and the drain terminal of the third transistor 202 is electrically connected to the one terminal of the light-emitting element. Thus, even though the capacitance of the capacitor element 203 is small, the electric charge relaxation time τ can be extended by increasing the resistance r of the resistor element 204. Therefore, the addition of the resistor element 204 makes it possible to minimize the electrode area of the capacitor element 203. As a result, the aperture ratio of the display device can be increased and a light emission time necessary for performing impulse-type display can be obtained.

In the circuit configuration of FIG. 3, in contrast to the circuit configuration of FIG. 1, potential of the power supply line can be applied to the light-emitting element 205 without the resistor element 204 when the third transistor 202 is on. Therefore, unlike the circuit configuration of FIG. 1, it is not necessary to increase the potential of the power supply line by the amount of the voltage drop.

Further, the time for accumulating electric charge in the capacitor element 203 is desirably shorter than one horizontal period. When the electric charge is accumulated within one horizontal period, the light-emitting element can emit light at desired luminance.

In this manner, a light emission time necessary for performing impulse-type display which is suitable for motion image display can be obtained. Therefore, motion image display with less afterimages can be performed.

Note that this embodiment mode can be combined with any of the other embodiment modes as appropriate.

### Embodiment Mode 3

This embodiment mode describes another structure of a pixel in a display device.

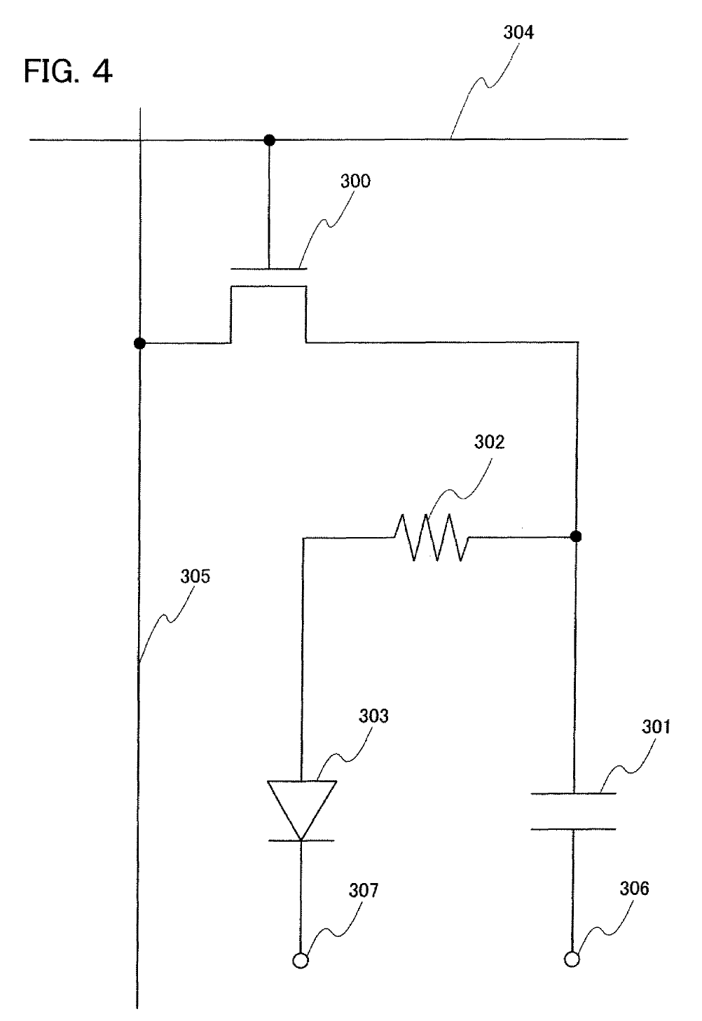

A pixel in a display device of this embodiment mode will be described with reference to FIG. 4. FIG. 4 shows a circuit diagram illustrating the structure of the pixel in the display device of this embodiment mode.

As illustrated in FIG. 4, the pixel in the display device of this embodiment mode includes a transistor 300, a capacitor element 301, a resistor element 302, and a light-emitting element 303 electrically connected to the transistor 300.

A gate terminal of the transistor 300 is electrically connected to a scanning line 304 provided in the display device, and one of a source terminal and a drain terminal of the transistor 300 is electrically connected to a signal line 305 provided in the display device. The transistor 300 is turned on or off depending on whether Vgs applied to the transistor 300 is higher or lower than Vth of the transistor 300. When the transistor 300 is on, signal potentials of the signal line 305 are applied to one terminal of the capacitor element 301 via the transistor 300 and to one terminal of the light-emitting element 303 via the transistor 300 and the resistor 302.

Note that, for example, transistors which can be used as the first transistor 100 and the second transistor 101 in Embodiment Mode 1, or the like can be used as the transistor 300.

The one terminal of the capacitor element 301 is electrically connected to the other of the source terminal and the drain terminal of the transistor 300 and the other terminal of the capacitor element 301 is electrically connected to a first potential supply terminal 306. A ground potential or a potential of a predetermined value is applied to the capacitor element 301 via the first potential supply terminal 306. The capacitor element 301 has a function as an auxiliary capacitor for adjusting the light emission time of the light-emitting element 303 in the pixel and has a function of temporarily retaining electric charge corresponding to the difference between the potential applied to the one terminal of the light-emitting element 303 and the potential applied to the other terminal of the light-emitting element 303. When the transistor 300 is on, a data signal is applied from the signal line 305 to the capacitor element 301 and electric charge corresponding to the difference between potentials applied to the one terminal and the other terminal of the capacitor element 301 is accumulated in the capacitor element 301.

The capacitor element 301 desirably has a capacitance so that electric charge can be accumulated within a time for writing display data to the pixel. The capacitor element 301 can be formed using, for example, the structure, the material, and the like which can be employed to the capacitor 102 in Embodiment Mode 1.

The resistor element 302 has a function for adjusting the light emission time of the light-emitting element 303. By the addition of the resistor element, the capacitance of the capacitor element 301 which is necessary for performing impulse-type display can be decreased. The resistor element 302 can be formed using, for example, the structure, the material, and the like which can be employed to the resistor element 103 in Embodiment Mode 1. In this case, the resistance of the resistor element 302 and the capacitance of the capacitor element 301 are desirably set so that the electric charge relaxation time obtained by multiplying the resistance and the capacitance is equal to the light emission time necessary for performing impulse-type display.

The one terminal of the light-emitting element 303 is electrically connected to the one terminal of the capacitor element 301 via the resistor 302, and the other terminal of the light-emitting element 303 is electrically connected to a second potential supply terminal 307. A ground potential or a potential of a predetermined value is applied to the light-emitting element 303 via the second potential supply terminal 307. When the transistor 300 is on, a data signal (a potential) is applied from the signal line 305 to the one terminal of the light-emitting element 303 via the transistor 300 so that voltage is applied between the one terminal and the other terminal of the light-emitting element. Then, current flows to the light-emitting element 303, whereby the light-emitting element 303 emits light. The luminance of the light-emitting element 303 changes depending on the amount of current that flows to the light-emitting element 303. Note that the light-emitting element 303 can be formed using, for example, the structure, the material, and the like which can be employed to the light-emitting element 104 in Embodiment Mode 1.

Next, a display operation of the pixel in the display device of this embodiment mode is described.

In the case of performing display in a predetermined pixel, a scanning signal (a potential) is input to the gate terminal of the transistor 300 via the scanning line 304 selected for writing display data to the pixel in a horizontal period, so that the transistor 300 is turned on in accordance with the potential applied to the gate terminal of the transistor 300. Then, a data signal (a potential) is applied from the signal line 305 to the one terminal of the capacitor element 301 and the one terminal of the light-emitting element 303 via the transistor 300, and electric charge corresponding to voltage applied between the one terminal and the other terminal of the capacitor element 301 is accumulated in the capacitor element 301. Current corresponding to the voltage applied between the one terminal and the other terminal of the light-emitting element 303 flows to the light-emitting element 303. The light-emitting element 303 emits light at luminance corresponding to the amount of the flowing current and thus performs display.

The display data writing is completed in this manner, and a scanning line in the next row or the next pixel is selected for writing display data to the next pixel. Then, the transistor 300 of the pixel after the display data writing has been performed is turned off and the electric charge relaxation occurs.

At this time, the electric charge accumulated in the capacitor element 301 is released to the light-emitting element 303. The light-emitting element 303 emits light and maintains a display state only during the electric charge relaxation time in which the electric charge accumulated in the capacitor element 301 is released.

The electric charge relaxation time τ of the light-emitting element 303 can be represented by Formula 1 shown in Embodiment Mode 1.

In this manner, the other of the source terminal and the drain terminal of the transistor 300 is electrically connected to the one terminal of the light-emitting element 303 via the resistor element 302, and the other of the source terminal and the drain terminal of the transistor 300 is electrically connected to the capacitor element 301. Thus, even though the capacitance of the capacitor element 301 is small, the electric charge relaxation time τ can be extended by increasing the resistance r of the resistor element 302. Therefore, the addition of the resistor element 302 makes it possible to minimize the electrode area of the capacitor element 301. As a result, the aperture ratio of the display device can be increased and a light emission time necessary for performing impulse-type display can be obtained.

Further, since the display device of this embodiment mode has a structure in which only one transistor is provided in the pixel, the aperture ratio can be further increased in comparison with that of another embodiment mode.

The electric charge accumulating time of the capacitor element 301 is desirably shorter than one horizontal period. By the electric charge accumulation within one horizontal period, the light-emitting element can emit light at desired luminance.

In this manner, the light emission time necessary for performing impulse-type display which is suitable for motion image display can be obtained. Therefore, motion image display with less afterimages can be performed.

Note that this embodiment mode can be combined with any of the other embodiment modes as appropriate.

### Embodiment Mode 4

This embodiment mode describes another structure of a pixel in a display device.

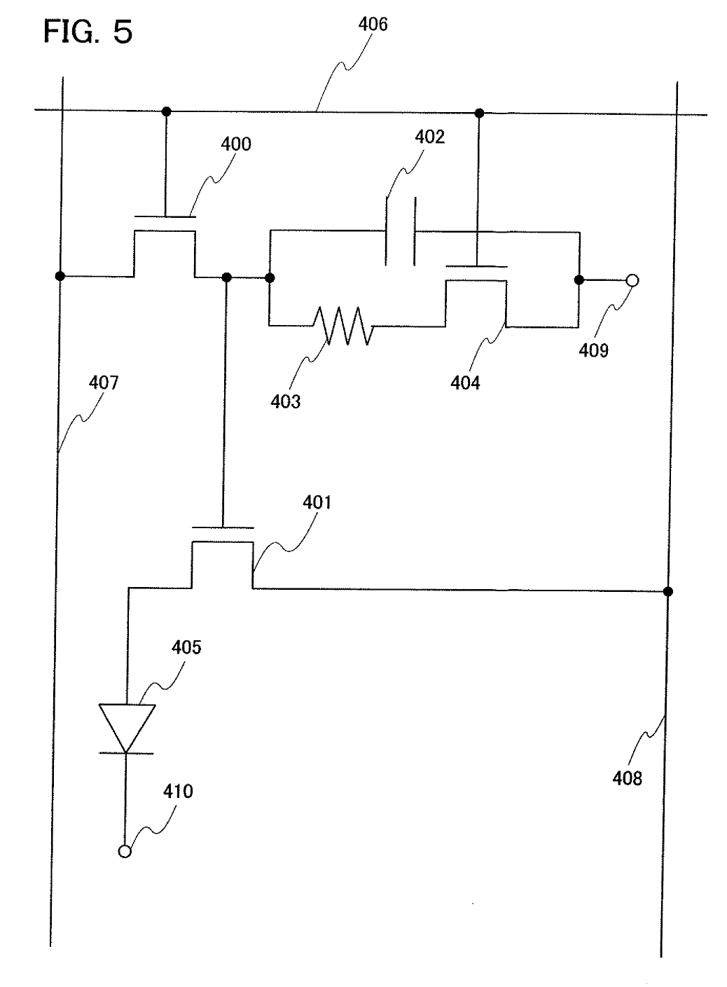

First, a pixel in a display device of this embodiment mode will be described with reference to FIG. 5. FIG. 5 shows a circuit diagram illustrating a structure of the pixel in the display device of this embodiment mode.

As illustrated in FIG. 5, the pixel in the display device of this embodiment mode includes a first transistor 400, a second transistor 401, a capacitor element 402, a resistor element 403, a third transistor 404, and a light-emitting element 405.

A gate terminal of the first transistor 400 is electrically connected to a scanning line 406 provided in the display device, and one of a source terminal and a drain terminal of the first transistor 400 is electrically connected to a signal line 407 provided in the display device. The first transistor 400 has a function as a switching transistor and is turned on or off depending on whether Vgs applied to the first transistor 400 is higher or lower than Vth of the first transistor 400. When the first transistor 400 is on, a signal potential of the signal line 407 is applied to a gate terminal of the second transistor 401 via the first transistor 400.

The gate terminal of the second transistor 401 is electrically connected to the other of the source terminal and the drain terminal of the first transistor 400, and one of a source terminal and a drain terminal of the second transistor 401 is electrically connected to a power supply line 408 provided in the display device. The second transistor 401 has a function for controlling the light-emitting element 405 and is turned on or off depending on whether Vgs applied to the second transistor 401 is higher or lower than Vth of the second transistor 401.

When a potential of a predetermined value is applied to the other of the source terminal and the drain terminal of the second transistor 401 via the power supply line 408, the potential of a certain value can be applied to one terminal of the light-emitting element 405; thus, decrease or variation in luminance can be suppressed. Therefore, the pixel structure of the display device in this embodiment mode can be employed to even a display device with a panel size of, for example, 5 inches or more.

One terminal of the capacitor element 402 is electrically connected to the other of the source terminal and the drain terminal of the first transistor 400, and the other terminal of the capacitor element 402 is electrically connected to a first potential supply terminal 409. A ground potential or a potential of a predetermined value is applied to the capacitor element 402 via the first potential supply terminal 409. The capacitor element 402 has a function as an auxiliary capacitor for adjusting the light emission time of the light-emitting element 405 in the pixel. When the first transistor 400 is on, a potential of a predetermined value is applied from the signal line 407 to the one terminal of the capacitor element 402 via the first transistor 400, and electric charge corresponding to the potential difference applied between the one terminal and the other terminal of the capacitor element 402 is accumulated in the capacitor element 402.

The capacitor element 402 desirably has a capacitance so that electric charge can be accumulated within a time for writing display data to the pixel. Note that the capacitor element 402 can be formed using, for example, the structure, the material, and the like which can be employed to the capacitor element 102 in Embodiment Mode 1.

The resistor element 403 has a function for adjusting the light emission time of the light-emitting element 405. By the addition of the resistor element, the capacitance of the capacitor element 402 can be decreased. Note that the resistor element 403 can be formed using, for example, the structure, the material, and the like which can be employed to the resistor element 103 in Embodiment Mode 1. In this case, the resistance of the resistor element 403 and the capacitance of the capacitor element 402 are desirably set so that the electric charge relaxation time obtained by multiplying the resistance and the capacitance is equal to the light emission time necessary for performing impulse-type display.

A gate terminal of the third transistor 404 is electrically connected to the scanning line 406. One of a source terminal and a drain terminal of the third transistor 404 is electrically connected to the other of the source terminal and the drain terminal of the first transistor 400 via the resistor 403, and the other of the source terminal and the drain terminal of the third transistor 404 is electrically connected to the other terminal of the capacitor 402. The third transistor 404 has a function as a switching element for controlling to release the electric charge accumulated in the capacitor element 402 and is turned on or off depending on whether Vgs applied to the third transistor 404 is higher or lower than Vth of the third transistor 404. The other of the source terminal and the drain terminal of the third transistor 404 is electrically connected to the first potential supply terminal 409. A ground potential or a potential of a predetermined value is applied to the third transistor 404 via the first potential supply terminal 409.

Note that the first transistor 400 and the third transistor 404 desirably have different conductivity types (p type or n type). By the use of transistors having different conductivity types, it is easy to make one of the first transistor 400 and the third transistor 404 on when the other is off and to make one of them is off when the other is on.

As the first transistor 400 to the third transistor 404, for example, transistors which can be used as the first transistor 100 and the second transistor 101 in Embodiment Mode 1, or the like can be used.

The one terminal of the light-emitting element 405 is electrically connected to the other of the source terminal and the drain terminal of the second transistor 401, while the other terminal of the light-emitting element 405 is electrically connected to a second potential supply terminal 410. A ground potential or a potential of a predetermined value is applied to the light-emitting element 405 via the second potential supply terminal 410. When the second transistor 401 is on, a power supply potential is applied from the power supply line 408 to the one terminal of the light-emitting element 405 via the second transistor 401 so that voltage is applied between the one terminal and the other terminal of the light-emitting element 405. Then, current flows to the light-emitting element 405, whereby the light-emitting element 405 emits light. The luminance of the light-emitting element 405 changes depending on the amount of the flowing current. Note that the light-emitting element 405 can be formed using, for example, the structure, the material, and the like which can be employed to the light-emitting element 104 in Embodiment Mode 1.

Next, a display operation of the pixel in the display device of this embodiment mode is described.

In the case of performing display in a predetermined pixel, a scanning signal is input to the gate terminal of the first transistor 400 via the scanning line 406 selected for writing display data to the pixel, and the first transistor 400 is turned on in accordance with the potential given to the gate terminal of the first transistor 400. Then, a data signal (a potential) is input from the signal line 407 to the gate terminal of the second transistor 401 via the first transistor 400. Moreover, a data signal (a potential) is input from the signal line 407 via the first transistor 400 and a potential corresponding to the data signal is applied to the one terminal of the capacitor element 402. Then, electric charge corresponding to potential difference between the one terminal and the other terminal of the capacitor element 402 is accumulated in the capacitor element 402. Here, a ground potential is applied to the other terminal of the capacitor element 402.

Further, the second transistor 401 is turned on in accordance with the potential of the gate terminal, and a potential of a predetermined value (here, a potential of the power supply) is applied from the power supply line 408 to the one terminal of the light-emitting element 405 via the second transistor 401. Thus, voltage is applied between the one terminal and the other terminal of the light-emitting element 405. Moreover, current corresponding to the voltage applied to the light-emitting element 405 flows to the light-emitting element 405, and the light-emitting element 405 emits light at luminance corresponding to the amount of the flowing current and thus performs display. At this time, a ground potential is applied to the other terminal of the light-emitting element 405.

The display data writing is completed in this manner, and a scanning line in the next row or the next pixel is selected for writing display data to the next pixel. Then, the first transistor 400 of the pixel after the display operation has been performed is turned off and the third transistor 404 is turned on.

At this time, the electric charge accumulated in the capacitor element 402 is released via the resistor element 403. By the release of the electric charge, the potential of the gate terminal of the second transistor 401 decreases, so that the state of the second transistor 401 changes from on to off. As the state of the second transistor 401 changes from on to off, the resistance of the second transistor 401 increases to thereby decrease the voltage applied to the light-emitting element 405; therefore, the light emission luminance decreases. The light emission time of the light-emitting element 405 is adjusted so as to be the light emission time necessary for performing impulse-type display. A relaxation time If in which the capacitor element 402 releases electric charge corresponds to the light emission time and is represented by the formula τ_{f}=Cs×r where Cs is the capacitance of the capacitor element 402 and r is the resistance of the resistor element 403.

In this manner, the capacitor element 402 is electrically connected to the other of the source terminal and the drain terminal of the first transistor 400 via the resistor 403; therefore, the light emission time of the light-emitting element 405 can be made shorter than one frame period even using a display device of a conventional hold-type display. Furthermore, the aperture ratio can be increased by minimizing the electrode area of the capacitor element 402, and the light emission time necessary for performing impulse-type display can be obtained.

In comparison with the circuit configurations of FIG. 1 in Embodiment Mode 1 and of FIG. 3 in Embodiment Mode 2, it is not necessary to increase the potential of the power supply line by the amount of the voltage drop due to the resistor element in the circuit configuration of FIG. 5 in this embodiment mode. Further, in comparison with the circuit configuration of FIG. 3, it is not necessary to apply a negative potential to the other terminal of the capacitor element in the circuit configuration of FIG. 5.

The time for accumulating electric charge in the capacitor element 402 is desirably shorter than one horizontal period. When the electric charge is accumulated within one horizontal period, the light-emitting element 405 can emit light at desired luminance.

In this manner, the light emission time necessary for performing impulse-type display which is suitable for motion image display can be obtained. Therefore, motion image display with less afterimages can be performed.

Note that this embodiment mode can be combined with any of the other embodiment modes as appropriate.

### Embodiment Mode 5

This embodiment mode describes structures of transistors each of which can be used for a pixel in a display device.

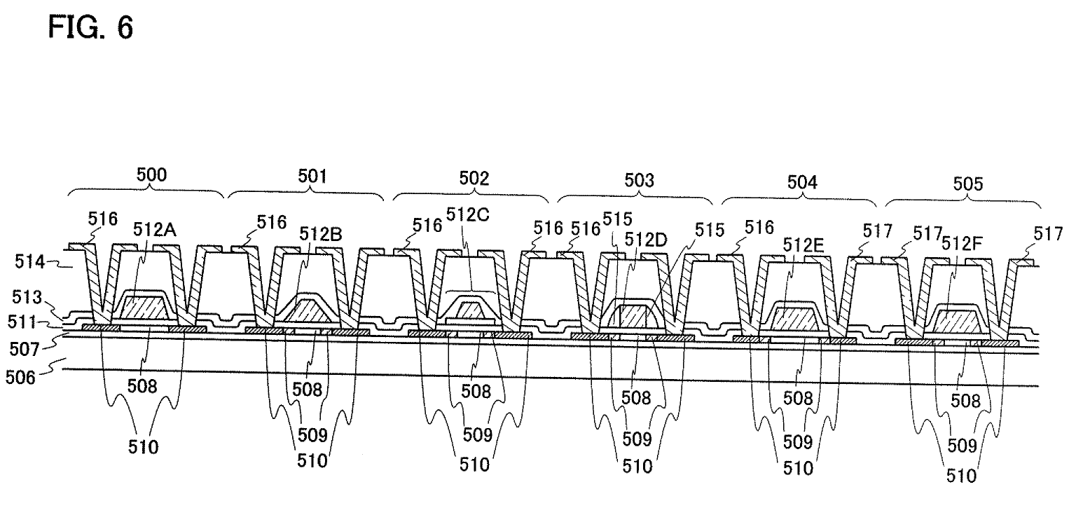

In any of Embodiment Modes 1 to 4, the transistor used for the pixel can have the structure described below. The structures of transistors each of which can be used for the pixel of the display device are described with reference to FIG. 6. FIG. 6 shows a schematic view illustrating structure examples of transistors in this embodiment mode.

As illustrated in FIC 6, a first transistor 500, a second transistor 501, a third transistor 502, a fourth transistor 503, a fifth transistor 504, a sixth transistor 505, or the like can be selected as appropriate as the transistor which can be used for the pixel in the display device of this embodiment mode. Each transistor includes a substrate 506, a base film 507 provided over the substrate 506, a semiconductor layer 508 which is provided over the base film 507 and which includes impurity regions 510, a gate insulating film 511 provided so as to cover the semiconductor layer 508, one of a gate electrode 512A, a gate electrode 512B, a gate electrode 512C, a gate electrode 512D, a gate electrode 512E, and a gate electrode 512F which are provided over parts of the gate insulating film 511, a first insulating film 513 provided so as to cover the semiconductor layer 508 with any one of the gate electrodes 512A to 512F and the gate insulating film 511 interposed therebetween, a second insulating film 514 provided over the first insulating film 513, and wirings 516 provided in contact with the impurity regions 510 in the semiconductor layer 508 through the second insulating film 514, the first insulating film 513, and the gate insulating film 511 interposed therebetween.

The semiconductor layer 508 includes the impurity regions 510 and also includes a channel region below each of the gate electrodes 512A to 512F. Each impurity region 510 serves as a source region or a drain region. The plural transistors having different structures are illustrated in line in FIG. 6 for convenience; however, the transistors are not necessarily arranged in line and can be manufactured separately as needed.

Next, the structure of each transistor in FIG. 6 is described.

The first transistor 500 is a single drain-type transistor. Since the single drain-type transistor can be formed by a simple method, it has advantages of low manufacturing cost and high yield. By the control of the amount of impurities added to the semiconductor layer 508 of the first transistor 500, the resistivity of the semiconductor layer 508 can be controlled. The connection between the semiconductor layer 508 and the wirings 516 can be made close to ohmic connection. Note that as a method of separately forming the semiconductor layers each including a different amount of impurities, a method in which impurities are added to the semiconductor layer 508 using the gate electrode 512A as a mask can be used.

The second transistor 501 is a transistor having high reliability in which the gate electrode 512B is tapered at an angle of at least certain degrees and which can be formed by a simple method. Therefore, it has advantages of low manufacturing cost and high yield. The semiconductor layer of the second transistor 501 includes low-concentration impurity regions 509 each provided between the impurity region 510 and the channel region. The impurity region 510, the channel region, and the low-concentration impurity region 509 have different impurity concentrations. The low-concentration impurity regions 509 provided below the gate electrode 512B are used as lightly doped drain (LDD) regions. Since the transistor includes the LDD regions, strength of an electric field at a drain edge of the transistor can be reduced, so that degradation of electric characteristics of the transistor due to hot carriers can be suppressed. Note that as a method of separately forming the semiconductor layers having different amounts of impurities, a method in which the semiconductor layer 508 is doped with impurities using the gate electrode 512B as a mask can be used. In the transistor 501, since the gate electrode 512B has a tapered angle of at least certain degrees, the concentration of impurities added to the semiconductor layer 508 through the gate electrode 512B can be gradual, and the LDD regions can be easily formed without a photomask.

The third transistor 502 is a transistor in which the gate electrode 512C includes at least two layers and a lower gate electrode is longer than an upper gate electrode. In this specification, the shape of the upper gate electrode and the lower gate electrode is referred to as a hat shape. When the gate electrode has a hat shape, LDD regions can be formed without addition of a photomask. Note that a structure where the LDD regions overlap with the gate electrode, like the third transistor 502, is particularly called a GOLD (Gate OverLapped Drain) structure. As a method of forming the gate electrode with a hat shape, the following method can be used.

First, patterning the gate electrode 512C is performed by dry etching using difference in etching rate between the lower gate electrode and the upper gate electrode; thus, the gate electrode 512C is formed with its side surface being tapered. Then, anisotropic etching is performed so that the upper gate electrode is made as steep as perpendicular. Thus, the gate electrode is formed such that the cross section is hat-shaped. After that, an impurity element is added to form the channel region, the low-concentration impurity regions 509 used as the LDD regions, and the impurity regions 510 each used as a source electrode or a drain electrode.

Note that a part of the LDD region, which overlaps with the gate electrode is referred to as an Lov region, and a part of the LDD region, which does not overlap with the gate electrode, is referred to as an Loff region. Here, the Loff region serves effectively in reducing off-current; however, it does not serve effectively in preventing drop in on-current due to hot carriers by suppressing the electric field at the drain edge. On the other hand, the Lov region serves effectively in preventing drop in on-current by suppressing the electric field at the drain edge; however, it does not serve effectively in reducing off-current. Thus, it is preferable to use a transistor whose structure has characteristics required for each of variety of circuits. For example, in transistors used for each circuit of the display device, a transistor having an Loff region is preferably used as a transistor in a pixel portion in order to reduce off-current.

The fourth transistor 503 is a transistor including sidewalls 515 which is in contact with side surfaces of the gate electrode 512D. By the provision of the sidewalls 515, regions overlapping with the sidewalls 515 in a semiconductor layer can serve as LDD regions.

The fifth transistor 504 is a transistor including LDD (Loff) regions provided by doping the semiconductor layer 508 with the use of a photomask Thus, the LDD regions can surely be formed, and off-current of the transistor can be reduced.

The sixth transistor 505 is a transistor including LDD (Lov) regions provided by doping the semiconductor layer 508 with an impurity element using a photomask. By this structure, the LDD regions can surely be formed, and drop in on-current can be prevented by suppressing electric field at the drain edge of the transistor.

Next, materials of each transistor are described.

The substrate 506 can be a glass substrate made of barium borosilicate glass, aluminoborosilicate glass, or the like, a quartz substrate, a ceramic substrate, a metal substrate such as a stainless steel substrate, or the like. Alternatively, a substrate formed of a synthetic resin having flexibility, such as acrylic or plastic typified by polyethylene terephthalate (PEST), polyethylene naphthalate (PEN), and polyethersulone (PES), can be also used. By using a flexible substrate, a foldable semiconductor device can be manufactured. A flexible substrate has no strict limitations on the area or the shape of the substrate. Accordingly, for example, when a substrate having a rectangular shape, each side of which is 1 meter or more, is used as the substrate 506, productivity can be significantly improved. This is a major advantage as compared to the case of using a circular silicon substrate.

The base film 507 has a function for preventing an alkali metal such as Na or an alkaline earth metal in the substrate 506 from adversely affecting the characteristics of a semiconductor element. The base film 507 can have a single-layer structure or a stacked-layer structure of an insulating film containing oxygen or nitrogen, such as silicon oxide, silicon nitride, silicon oxynitride, or silicon nitride oxide. For example, when the base film 507 is provided to have a two-layer structure, it is preferable to provide a silicon nitride oxide film as a first base film and a silicon oxynitride film as a second base film. As another example, when the base film 507 is provided to have a three-layer structure, it is preferable to provide a silicon oxynitride film as a first base film, a silicon nitride oxide film as a second base film, and a silicon oxynitride film as a third base film.

The semiconductor layer 508 may be formed using an amorphous semiconductor, a microcrystal semiconductor, or a polycrystalline semiconductor. The microcrystalline semiconductor has an intermediate structure between an amorphous structure and a crystalline structure (including a single crystal structure and a polycrystalline structure) and has a stable state in terms of free energy. The microcrystalline semiconductor further includes a crystalline region having a short range order along with lattice distortion. A crystal region of 0.5 to 20 nm is included in at least part of the microcrystalline semiconductor film. In the case of containing silicon as its main component, Raman spectrum is shifted to the lower wavenumber side than 520 cm⁻¹. The diffraction peaks of (111) and (220) that are said to be derived from a silicon crystal lattice are observed by X-ray diffraction. Hydrogen or halogen is contained by 1 at. % or more to compensate a dangling bond. A microcrystal is formed by glow diselectric charge decomposition (plasma CVD) of a source gas. As the source gas, SiH₄ can be used; alternatively, Si₂H₆, SiH₂Cl₂, SiHCl₃, SiCl₄, SiF₄, or the like can be used. Further, GeF₄ may be mixed. Alternatively, the source gas may be diluted with H₂, or H₂ and one or more kinds of rare gas elements selected from He, Ar, Kr, and Ne. The dilution ratio is 2 or more and 1000 or less. The pressure is 0.1 Pa or more and 133 Pa or less, and the power supply frequency is 1 MHz or more and 120 MHz or less, preferably 13 MHz or more and 60 MHz or less. The substrate heating temperature may be 300° C. or less. The impurities of atmospheric components such as oxygen, nitrogen, and carbon in the film are desirably 1×10²⁰ cm⁻³ or less in concentration; particularly, the oxygen concentration is 5×10¹⁹ cm⁻³ or less, preferably 1×10¹⁹ cm⁻³ or less. Here, an amorphous semiconductor layer is formed using a material containing silicon as a main component (for example, SiₓGe₁₋ₓ) by a sputtering method, an LPCVD method, a plasma CVD method, or the like and then, the amorphous semiconductor layer is crystallized by a crystallization method such as a laser crystallization method, a thermal crystallization method using RTA or an annealing furnace, or a thermal crystallization method using a metal element which promotes crystallization.

The gate insulating film 511 can have a single-layer structure or a stacked-layer structure of an insulating film containing oxygen or nitrogen, such as silicon oxide, silicon nitride, silicon oxynitride, or silicon nitride oxide.

Each of the gate electrodes 512A to 512F can have a single-layer structure of a conductive film or a stacked-layer structure of two or three conductive films. As the material of each of the gate electrodes 512A to 512F, a conductive film can be used. For example, a film of single element of tantalum, titanium, molybdenum, tungsten, chromium, silicon, or the like; a nitride film containing the above element (typically, a tantalum nitride film, a tungsten nitride film, or a titanium nitride film); an alloy film in which the above elements are used in combination (typically, a Mo—W alloy or a Mo—Ta alloy); a silicide film containing the above element (typically, a tungsten silicide film or a titanium silicide film); or the like can be used. Note that the film of single element, the nitride film, the alloy film, the silicide film, and the like as aforementioned can each have a single-layer structure or a stacked-layer structure.

The first insulating film 513 can have a single-layer structure of an insulating film containing oxygen or nitrogen, such as silicon oxide, silicon nitride, silicon oxynitride, or silicon nitride oxide, or a film containing carbon such as DLC (diamond-like carbon) or can have a stacked-layer structure including any of these films.

The second insulating film 514 can have a single-layer structure or a stacked-layer structure of a siloxane resin; an insulating film containing oxygen or nitrogen, such as silicon oxide, silicon nitride, silicon oxynitride, or silicon nitride oxide; a film containing carbon such as DLC (diamond-like carbon); or an organic material such as epoxy, polyimide, polyamide, polyvinyl phenol, benzocyclobutene, or acrylic. The siloxane resin corresponds to a resin including a Si—O—Si bond. Siloxane has a skeleton structure formed by the bond of silicon and oxygen. As a substituent, an organic group containing at least hydrogen (for example, an alkyl group or aromatic hydrocarbon) is used. As a substituent, a fluoro group can alternatively be used. Further alternatively, a fluoro group and an organic group containing at least hydrogen can be used as a substituent. Note that the second insulating film 514 can be directly provided so as to cover the gate electrodes 512A to 512F without provision of the first insulating film 513.

As the wirings 516, a film of single element of aluminum, nickel, carbon, tungsten, molybdenum, titanium, platinum, copper, tantalum, gold, manganese, or the like, a nitride film containing the above element, an alloy film in which the above elements are used combination, a silicide film containing the above element, or the like can be used. For example, as an alloy containing a plurality of the above elements, an aluminum alloy containing carbon and titanium, an aluminum alloy containing nickel, an aluminum alloy containing carbon and nickel, an aluminum alloy containing carbon and manganese, or the like can be used. For example, when the wirings have a stacked-layer structure, aluminum is interposed between molybdenum, titanium, or the like. This stacked-layer structure can increase the resistance of aluminum against heat and a chemical reaction.

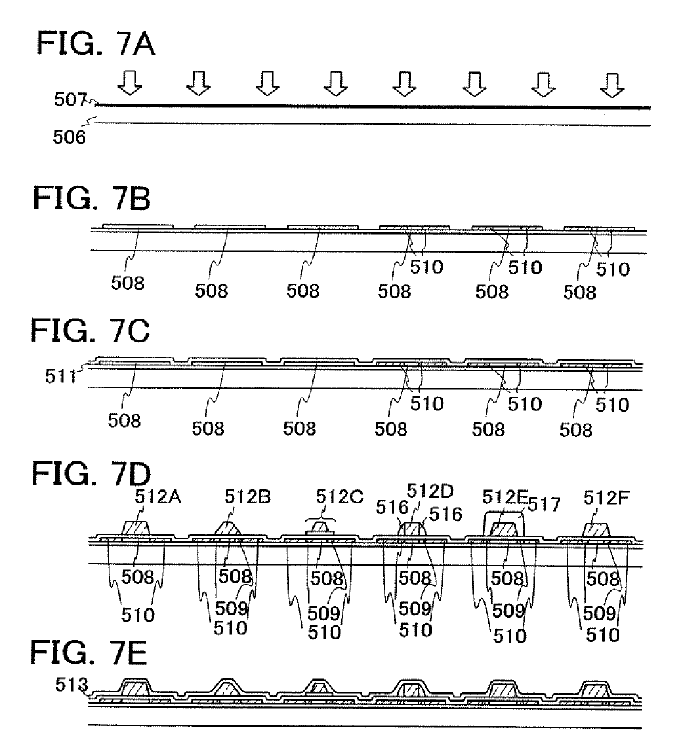

Next, an example of a method of manufacturing each transistor is described with reference to FIGS. 7A to 7E. FIGS. 7A to 7E are schematic views illustrating the methods of manufacturing the transistors. The methods of manufacturing the transistors are not limited to those illustrated in FIGS. 7A to 7E, and a variety of manufacturing methods can be employed.

First, as illustrated in FIG. 7A, the base film 507 is formed over the substrate 506. Next, a surface of the base film 507 is oxidized or nitrided by plasma treatment. Note that this plasma treatment can also be performed after another layer is formed in this manufacturing method. By the oxidizing or nitriding of the semiconductor layer or the insulating film by plasma treatment in such a manner, a surface of the semiconductor layer or the insulating film can be modified and an insulating film can be formed to be denser than an insulating film formed by a CVD method or a sputtering method; thus, a defect such as a pinhole can be suppressed and the characteristics and the like of the semiconductor device can be improved.

Next, as illustrated in FIG. 7B, the semiconductor layer 508 is formed over parts of the oxidized or nitrided base film 507. Moreover, the impurity regions 510 are formed in parts of the semiconductor layer 508 with use of a resist mask or the like.

Then, as illustrated in FIG. 7C, the gate insulating film 511 is formed so as to cover the semiconductor layer 508 and the base film 507.

Next, as shown in FIG. 7D, the gate electrodes 512A to 512F are formed over parts of the semiconductor layer 508 with the gate insulating film 511 interposed therebetween. Further, one of the gate electrodes 512A to 512F (the gate electrode 512D) is provided with the sidewalls 515. The sidewalls 515 can be formed of silicon oxide or silicon nitride. As a method of forming the sidewalls 515 on the side surfaces of the gate electrode 512D, a method can be used, for example, in which the gate electrode 512D is formed, a silicon oxide film or a silicon nitride film is formed, and then the silicon oxide film or the silicon nitride film is etched by anisotropic etching. Thus, the silicon oxide or silicon nitride film remains only on the side surfaces of the gate electrode 512D, so that the sidewalls 515 can be formed on the side surfaces of the gate electrode 512D. Further, the low-concentration impurity regions 509 are formed in some part of the semiconductor layer 508 by using the gate electrodes, an additional resist mask, and the like.

Next, as shown in FIG. 7E, the first insulating film 513 is formed so as to cover the gate insulating film 511 and the gate electrodes 512A to 512F. Note that the first insulating film 513 can be formed by a sputtering method, a plasma CVD method, or the like. After that, the second insulating film 514 and the wirings 516 are formed, whereby the transistors having the structures as illustrated in FIG. 6 are formed.

As thus described, a more accurate display operation can be performed by selecting as appropriate the structure of the transistor in accordance with the purpose.

Further, an example of using a semiconductor substrate as the substrate over which the transistor is formed is described. The transistor manufactured with a semiconductor substrate has high mobility; therefore, large on-current can be obtained at low operation voltage. As a result, the transistor can be smaller in size, so that the number of transistors per unit area (i.e., increase the integration degree) increases. In the same circuit configuration, the substrate size can be smaller as the integration degree of transistors is higher; therefore, the manufacturing cost can be decreased. Moreover, in the case of the same substrate size, the circuit scale can be increased as the integration degree of transistors increases; therefore, higher performance can be achieved with almost the same manufacturing cost. Moreover, reduction in variations in characteristics of transistors can improve production yield. Further, low operation voltage due to high mobility of transistors can reduce power consumption of integrated circuits. Furthermore, a high-speed operation of integrated circuits is possible.

A circuit which is formed by integrating the transistors formed using the semiconductor substrate can also be used for a display panel (a display portion), for example. More specifically, the circuit can be used for a reflective liquid crystal panel such as a liquid crystal on silicon (LCOS) device, a digital micromirror device (DMD) in which micromirrors are integrated, an EL panel, or the like. By forming such a display panel (display portion) using a semiconductor substrate, a display panel (display portion) which can operate with low power consumption and at high speed can be manufactured at low cost and in high yield. Note that the display panel (the display portion) includes circuits in addition to the circuit for driving the display panel (the display portion), such as large scale integration (LSI).

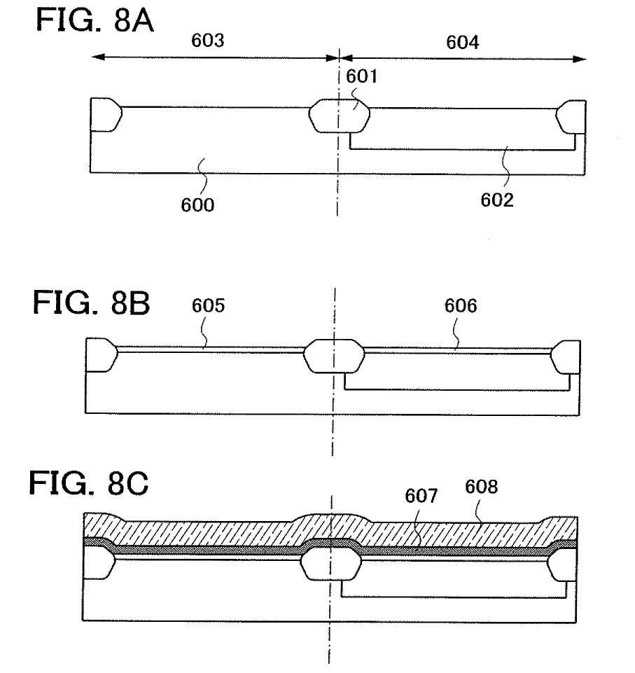

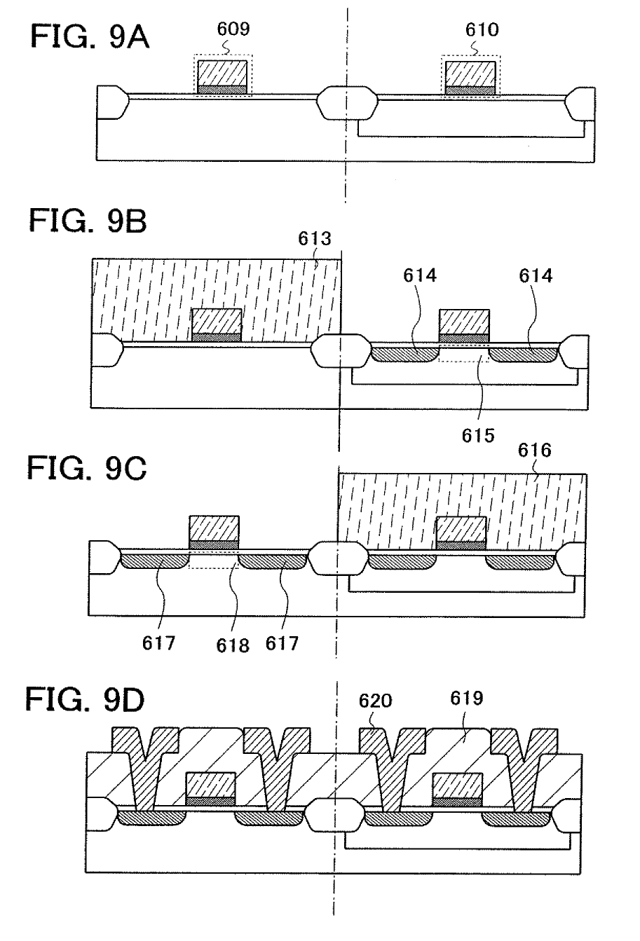

Next, a method of manufacturing transistors with use of a semiconductor substrate is described with reference to FIGS. 8A to 8C and FIGS. 9A and 9D. FIGS. 8A to 8C and FIGS. 9A and 9D illustrate a method of manufacturing transistors using a semiconductor substrate.

First, as illustrated in FIG. 8A, a first insulating film 601 (also referred to as a field oxide film) is provided in a semiconductor substrate 600, and a first element region 603 and a second element region 604 are formed which are separated by the insulating film 601 for each element. Moreover, a p well 602 is formed in part of the semiconductor substrate 600 in the second element region 604.

The semiconductor substrate 600 can be used without particular limitation as long as it is a semiconductor substrate. For example, a single crystal Si substrate having n-type or p-type conductivity, a compound semiconductor substrate (a GaAs substrate, an InP substrate, a GaN substrate, a SiC substrate, a sapphire substrate, a ZnSe substrate, or the like), an SOI (silicon on insulator) substrate formed by a bonding method or a SIMOX (separation by implanted oxygen) method, or the like can be used.

Next, as illustrated in FIG. 8B, a second insulating film 605 is formed over the semiconductor substrate 600 in the first element region 603, and a third insulating film 606 is formed over the semiconductor substrate 600 in the second element region 604.

For the second insulating film 605 and the third insulating film 606, a silicon oxide film formed by oxidizing surfaces of the first element region 603 and the second element region 604 provided in the semiconductor substrate 600 by heat treatment can be used, for example.

Then, as illustrated in FIG. 8C, a first conductive film 607 and a second conductive film 608 are formed over the semiconductor substrate 600 and the first insulating film 601.

Each of the first conductive film 607 and the second conductive film 608 can be formed using an element selected from tantalum, tungsten, titanium, molybdenum, aluminum, copper, chromium, niobium, or the like; or an alloy material or a compound material containing the above element as its main component. Alternatively, a metal nitride film obtained by nitridation of the above element can be used. Further alternatively, a semiconductor material typified by polycrystalline silicon doped with an impurity element such as phosphorus, or a silicide in which a metal material is introduced can be used.

Next, as illustrated in FIG. 9A, a first gate electrode 609 and a second gate electrode 610 are formed over part of the second insulating film 605 and part of the third insulating film 606, respectively. Moreover, as shown in FIG. 9B, a resist mask 613 is formed so as to cover the first gate electrode 609, the first insulating film 601, and the second insulating film 605 in the first element region 611. Then, an impurity is added to form impurity regions 614. Moreover, part of the semiconductor substrate 600 that is located below the second gate electrode 610 serves as a channel region 615.

Next, as shown in FIG. 9C, a resist mask 616 is formed over the second gate electrode 610, the first insulating film 601, and the third insulating film 606 in the second element region 612. Then, an impurity is added to form impurity regions 617. Moreover, part of the semiconductor substrate 600 that is located below the first gate electrode 609 serves as a channel region 618.

Next, as illustrated in FIG. 9D, a fourth insulating film 619 is formed so as to cover the first gate electrode 609, the second gate electrode 610, the first insulating film 601, the second insulating film 605, and the third insulating film 606. Then, wirings 620 are formed so as to be in contact with the impurity regions 614 or the impurity regions 617 through the fourth insulating film 619, the second insulating film 605, and the third insulating film 606.

The fourth insulating film 619 can have a single-layer structure or a stacked-layer structure using any of an insulating film containing oxygen or nitrogen, such as silicon oxide, silicon nitride (SiNₓ), silicon oxynitride, or silicon nitride oxide; a film containing carbon such as diamond-like carbon (DLC); an organic material such as epoxy, polyimide, polyamide, polyvinyl phenol, benzocyclobutene, or acrylic; a siloxane material such as a siloxane resin; and the like by a CVD method, a sputtering method, or the like. Note that the siloxane material corresponds to a material having a Si—O—Si bond. Siloxane has a skeleton structure formed by the bond of silicon and oxygen. As a substituent, an organic group containing at least hydrogen (for example, an alkyl group or aromatic hydrocarbon) is used. As a substituent, a fluoro group can be used. Alternatively, a fluoro group and an organic group containing at least hydrogen can be used as a substituent.

The wirings 620 are formed to have a single-layer structure or a stacked-layer structure using an element selected from aluminum, tungsten, titanium, tantalum, molybdenum, nickel, platinum, copper, gold, silver, manganese, neodymium, carbon, or silicon; or an alloy material or a compound material containing the above element as its main component by a CVD method, a sputtering method, or the like. The alloy material containing aluminum as its main component corresponds to, for example, a material containing aluminum as its main component and also containing nickel, or an alloy material containing aluminum as its main component and also containing nickel and one of or both carbon and silicon. The wirings 620 preferably have, for example, a stacked-layer structure of a first barrier film, an aluminum-silicon film, and a second barrier film or a stacked-layer structure of a first barrier film, an aluminum-silicon film, a titanium nitride film, and a second barrier film. Note that the barrier film corresponds to a thin film including titanium, a nitride of titanium, molybdenum, or a nitride of molybdenum. Aluminum and aluminum silicon which have low resistance and are inexpensive are optimal materials for forming the wirings 620. For example, when barrier layers are provided as a top layer and a bottom layer, generation of hillocks of aluminum or aluminum silicon can be prevented. For example, when a barrier film is formed of titanium, which is an element having a high reducing property, even if a thin native oxide film is formed on a crystalline semiconductor film, the native oxide film is reduced. Thus, the wirings 620 can be electrically and physically connected to the crystalline semiconductor film in favorable condition.

Note that the structure of the transistor is not limited to the illustrated structures. For example, a transistor having an inverted-staggered structure, a Fin FET structure, or the like can be employed. When a Fin FET structure is employed, a short-channel effect due to size reduction of a transistor can be suppressed, which is preferable.

The structures and manufacturing methods of the transistors have been described. Here, the wirings, the electrodes, the conductive layers, the conductive films, the terminals, vias, plugs, or the like are preferably formed of one or more elements selected from aluminum, tantalum, titanium, molybdenum, tungsten, neodymium, chromium, nickel, platinum, gold, silver, copper, magnesium, scandium, cobalt, zinc, niobium, silicon, phosphorus, boron, arsenic, gallium, indium, or tin; or a compound or an alloy material containing one or more of the above elements (e.g., indium tin oxide (ITO), indium zinc oxide (IZO), indium tin oxide containing silicon oxide (ITSO), zinc oxide, tin oxide, cadmium tin oxide, aluminum neodymium, magnesium silver, or molybdenum-niobium). Alternatively, the wirings, the electrodes, the conductive layers, the conductive films, the terminals, or the like are preferably formed of, for example, a substance obtained by using such compounds in combination. Further alternatively, they are preferably formed so as to contain a compound (silicide) of silicon and one or more of the above elements (such as aluminum silicon, molybdenum silicon, or nickel silicide), or a compound of nitrogen and one or more of the above elements (such as titanium nitride, tantalum nitride, or molybdenum nitride).

Note that silicon which can be used for the wirings, the electrodes, the conductive layers, the conductive films, the terminals, or the like may contain an n-type impurity (such as phosphorus) or a p-type impurity (such as boron). The impurity contained in silicon can increase the conductivity or enables the same performance as normal conductors. Thus, such silicon can be utilized easily as wirings, electrodes, or the like.

Note that silicon with a variety of crystallinity, such as single crystal silicon, polycrystalline silicon (polysilicon), or microcrystal silicon, can be used. Alternatively, silicon with no crystallinity, such as amorphous silicon, can be used. By the use of single crystal silicon or polycrystalline silicon, the resistance of the wirings, the electrodes, the conductive layers, the conductive films, the terminals, or the like can be reduced. By the use of amorphous silicon or microcrystal silicon, the wirings or the like can be formed by a simple process.

Note that since ITO(Indium-Tin-Oxide), IZO(Indium-Zinc-Oxide), ITSO(Indium-Tin-Silicon-Oxide), zinc oxide, silicon, tin oxide, and cadmium tin oxide have light-transmitting properties, they can be used for a portion which transmits light. They may be used for, for example, a pixel electrode or a common electrode.

Note that IZO is preferable since IZO is easily etched and processed. IZO hardly leaves a residue when it is etched. Therefore, when IZO is used for a pixel electrode, defects (such as short circuit or orientation disorder) of a liquid crystal element or a light-emitting element can be reduced.

The wirings, the electrodes, the conductive layers, the conductive films, the terminals, vias, or plugs may each have a single-layer structure or a multilayer structure. When a single-layer structure is employed, a process for manufacturing the wirings, the electrodes, the conductive layers, the conductive films, the terminals, or the like can be simplified; the process days and manufacturing cost can be reduced. Alternatively, when a multi-layer structure is employed, an advantage of each material can be effectively utilized while a disadvantage of each material can be reduced, so that wirings, electrodes, or the like with high performance can be formed. For example, a low-resistant material (such as aluminum) is included in a multilayer structure, thereby reducing the resistance of the wirings. As another example, by a stacked-layer structure in which a low heat-resistant material is interposed between high heat-resistant materials, the heat resistance of the wirings, the electrodes, or the like can be increased while utilizing the advantage of the low heat-resistant material. For example, a stacked-layer structure in which a layer including aluminum is interposed between layers including molybdenum, titanium, neodymium, or the like is preferable.

When the wirings, the electrodes, or the like are in direct contact with each other, an adverse effect is caused on each other in some cases. For example, in the case where a material of a wiring, an electrode, or the like is mixed into another wiring, electrode, or the like, the properties thereof change; thus, desired characteristics of the wirings, the electrodes, or the like cannot be obtained. As another example, in forming or manufacturing a high-resistant portion, a problem occurs so that the high-resistant portion cannot be formed normally. In such a case, a reactive material is preferably interposed between non-reactive materials or covered with a non-reactive material in a stacked-layer structure. For example, when ITO is connected to aluminum, an alloy of titanium, molybdenum, and neodymium is preferably interposed between the ITO and the aluminum. As another example, when silicon is connected to aluminum, an alloy of titanium, molybdenum, and neodymium is preferably interposed between the silicon and the aluminum.

Note that the term “wiring” indicates a portion including a conductor. The shape of a wiring may be, but not limited to, linear Therefore, electrodes are included in such wirings.

Note that a carbon nanotube may be used for the wirings, the electrodes, the conductive layers, the conductive films, the terminals, vias, plugs, or the like. Since a carbon nanotube has a light-transmitting property, the carbon nanotube can be used for a portion which transmits light. For example, a carbon nanotube may be used for a pixel electrode or a common electrode.

As thus described, a more accurate display operation can be performed by selecting as appropriate a transistor whose structure suits the characteristics of each circuit.

Note that this embodiment mode can be combined with any of the other embodiment modes as appropriate.

### Embodiment Mode 6

This embodiment mode describes a display device of the present invention.

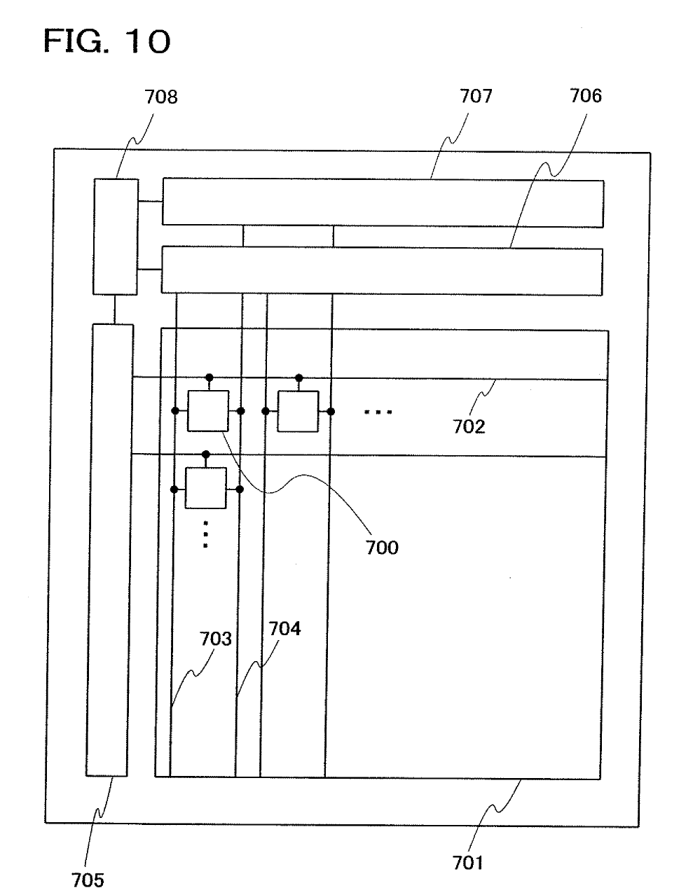

First, a structure of a display device of this embodiment mode is described with reference to FIG. 10. FIG. 10 shows a block diagram illustrating a structure of the display device of this embodiment mode.

As shown in FIG. 10, the display device of this embodiment mode includes a pixel portion 701 including a plurality of pixels 700, a scanning line 702, a signal line 703, a power supply line 704, a scanning line driver circuit 705 electrically connected to the scanning line 702, a signal line driver circuit 706 electrically connected to the signal line 703, a power supply circuit 708 electrically connected to the power supply line 704, and a control circuit 707 electrically connected to the scanning line driver circuit 705, the signal line driver circuit 706, and the power supply circuit 708.

The plurality of pixels 700 provided in the pixel portion 701 is arranged in matrix in intersection regions of the signal lines 703 and the scanning lines 702. A data signal can be input independently to each pixel. Each of the pixels 700 in the pixel portion 701 can have any of the pixel structures shown in FIG. 1 to FIG. 4. The scanning line 702, the signal line 703, and the power supply line 704 correspond to the scanning line 105, the signal line 106, and the power supply line 107 in FIG. 1 and the scanning line 206, the signal line 207, and the power supply line 208 in FIG. 3, respectively. In the case of employing the pixel structure of FIG. 4, the scanning line 702 and the signal line 703 correspond to the scanning line 304 and the signal line 305, respectively; the power supply line 704 and the power supply circuit 708 in FIG. 10 can be eliminated.

The control circuit 707 has a function for controlling the scanning line driver circuit 705, the signal line driver circuit 706, and the power supply circuit 708 in accordance with input video signals. Specifically, the control circuit 707 outputs control signals to the scanning line driver circuit 705 and the signal line driver circuit 706.

The scanning line driver circuit 705 has a function for outputting a scanning signal to the pixel 700 via the scanning line 702 in accordance with the control signal input from the control circuit 707.

The signal line driver circuit 706 has a function for outputting a data signal to the pixel 700 via the signal line 703 in accordance with the control signal input from the control circuit 707.

The power supply circuit 708 has a function for giving a potential of the power supply to the pixel 700 via the power supply line 704.

Next, examples of structures of the scanning line driver circuit and the signal line driver circuit of the display device in this embodiment mode are described.

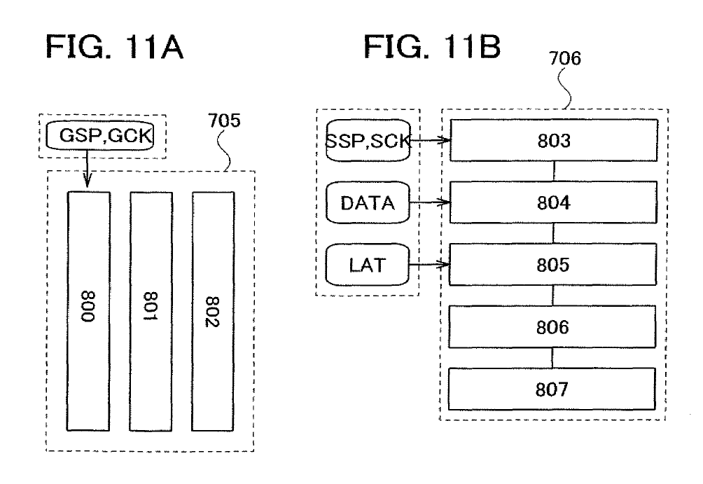

First, an example of a structure of the scanning line driver circuit is described with reference to FIG. 11A. FIG. 11A is a block diagram illustrating an example of a structure of the scanning line driver circuit in the display device of this embodiment mode.

As shown in FIG. 11A, the scanning line driver circuit 705 in FIG. 10 includes a shift register 800, a level shifter 801, and a buffer 802.

Signals such as a gate start pulse (GSP) and a gate clock signal (GCK) are input to the shift register 800.

Next, an example of a structure of the signal line driver circuit is described with reference to FIG. 11B. FIG 11B is a cross-sectional view illustrating an example of a structure of the signal line driver circuit in the display device of this embodiment mode.

As shown in FIG. 11B, the signal line driver circuit 706 in FIG. 10 includes a shift register 803, a first latch circuit 804, a second latch circuit 805, a level shifter 806, and a buffer 807.

The buffer 807 has a function for amplifying a signal and includes an operational amplifier or the like. Signals such as a start pulse (SSP) is input to the shift register 803, and data (DATA) of a video signal or the like is input to the first latch circuit 804. The second latch circuit 805 can hold a latch (LAT) signal temporally and output the held latch signals all at once to the pixel portion 701 in FIG. 10. This operation is referred to as a line sequential drive. Therefore, when the pixel performs a dot sequential drive instead of the line sequential drive, the second latch circuit 805 is not necessary.

Next, an operation of the display device in this embodiment mode is described.

Control signals are output from the control circuit 708 to the scanning line driver circuit 705 and the signal line driver circuit 706, whereby the scanning line driver circuit 705 outputs a scanning signal to the selected pixel via the scanning line 702. Further, the signal line driver circuit 706 outputs a data signal to the selected pixel 700 via the signal line 703. The selected pixel performs a display operation of the pixel selected from the pixels shown in Embodiment Mode 1 to Embodiment Mode 3, in accordance with the input scanning signal and data signal.

By performing impulse-type display in each pixel, motion images with less afterimages can be obtained in the pixel portion.

Note that this embodiment mode can be combined with any of the other embodiment modes as appropriate.

### Embodiment Mode 7

In this embodiment mode, electronic appliances each using a display device of the present invention for its display portion are described.

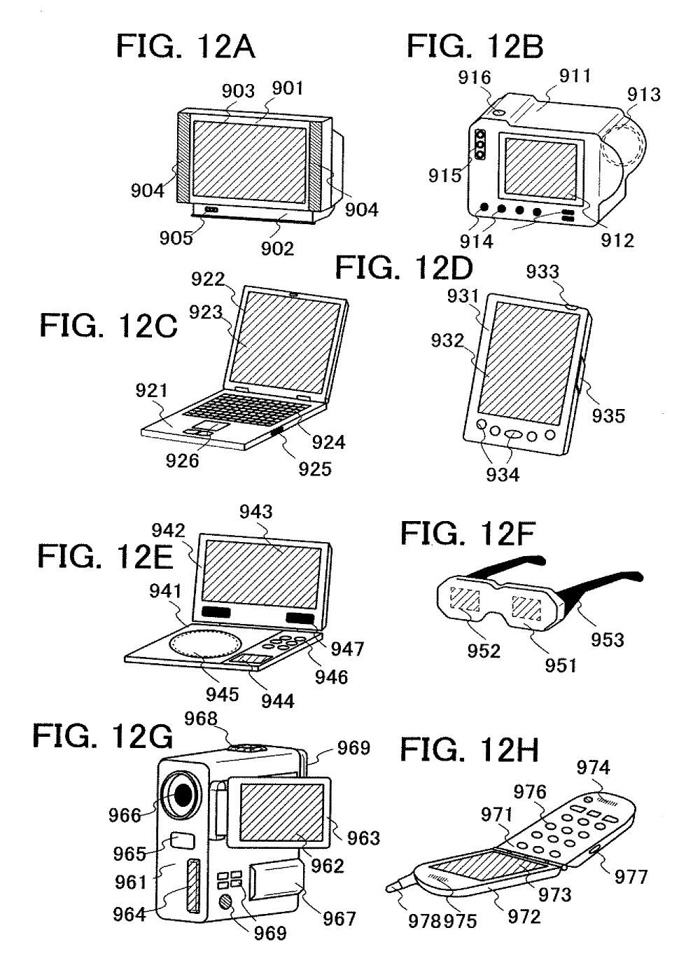

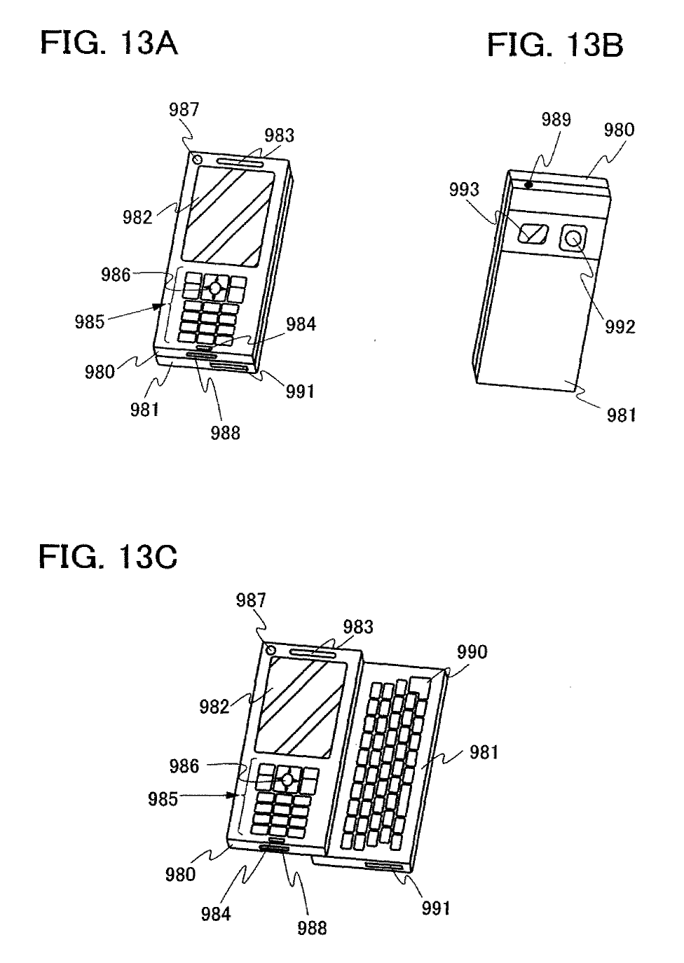

A display device of the present invention can be applied to a display portion of a variety of electronic appliances. Examples of electronic appliances to which the display device of the present invention can be applied include cameras such as video cameras and digital cameras, goggle type displays (head mounted displays), navigation systems, sound reproducing devices (a car audio, an audio component, and the like), notebook personal computers, game machines, cellular phones, portable information terminals (such as a mobile computer, a mobile music player, a portable game console, an electronic book, and a device which incorporates a computer and has a plurality of functions by performing a plurality of data processing), image reproducing devices provided with recording media (specifically, a device which reproduces a recording medium such as a Digital Versatile Disc (DVD) and is provided with a display capable of displaying the image), and the like. Specific examples of these electronic appliances are described with reference to FIGS. 12A to 12H and FIGS. 13A to 13C. FIGS. 12A to 12H and FIGS. 13A to 13C illustrate structures of electronic appliances of this embodiment mode.

FIG. 12A illustrates a display device including a housing 901, a supporting base 902, a display portion 903, speaker portions 904, a video input terminal 905, and the like. The display device of the present invention can be applied to the display portion 903. Note that the category of the display device includes all the display devices for personal computers, TV broadcast reception, advertisement display, and the like.

FIGS. 12B illustrates a digital still camera including a main body 911, a display portion 912, an image receiving portion 913, operation keys 914, an external connection port 915, a shutter button 916, and the like. A display device of the present invention can be applied to the display portion 912.

FIG. 12C illustrates a notebook personal computer including a main body 921, a housing 922, a display portion 923, a keyboard 924, an external connection port 925, a pointing device 926, and the like. A display device of the present invention can be applied to the display portion 923.

FIG. 12D illustrates a mobile computer including a main body 931, a display portion 932, a switch 933, operation keys 934, an infrared port 935, and the like. A display device of the present invention can be applied to the display portion 932.

FIG. 12E illustrates a portable image reproducing device provided with a recording medium (specifically, a DVD reproducing device), which has a main body 941, a housing 942, a display portion A943, a display portion B944, a recording medium (such as a DVD) reading portion 945, operation keys 946, speaker portions 947, and the like. The display portion A943 mainly displays image data, while the display portion B944 mainly displays text data. A display device of the present invention can be used for the display portion A943 and the display portion B944. The image reproducing device provided with the recording medium further includes a home-use game machine and the like in its category.

FIG. 12F illustrates a goggle type display (a head mounted display) including a main body 951, a display portion 952, an arm portion 953, and the like. A display device of the present invention can be applied to the display portion 952.

FIG. 12G illustrates a video camera including a main body 961, a display portion 962, a housing 963, an external connection port 964, a remote control receiving portion 965, an image receiving portion 966, a battery 967, a sound input portion 968, operation keys 969, and the like. A display device of the present invention can be applied to the display portion 962.

FIG. 12H illustrates a cellular phone including a main body 971, a housing 972, a display portion 973, a sound input portion 974, a sound output portion 975, operation keys 976, an external connection port 977, an antenna 978, and the like. A display device of the present invention can be applied to the display portion 973. Note that the display portion 973 displays white text on black screen so that current consumption of the mobile phone can be suppressed.

FIGS. 13A to 13C show an example of a portable information terminal having a plurality of functions. FIG. 13A is a front view, FIG. 13B is a rear view, and FIG. 13C is a development view of the portable information terminal. A portable information terminal one example of which is shown in FIGS. 13A to 13C can have a plurality of functions. For example, in addition to a phone function, a variety of data processing functions may be provided by incorporating a computer.

The portable information terminal shown in FIGS. 13A to 13C includes two housings: a housing 980 and a housing 981. The housing 980 is provided with a display portion 932, a speaker 983, a microphone 984, operation keys 985, a pointing device 986, a camera lens 987, an external connection terminal 988, an earphone terminal 989, and the like. The housing 981 is provided with a keyboard 990, an external memory slot 991, a camera lens 992, a light 993, and the like. In addition, an antenna is incorporated in the housing 981.

In addition to the above-described structure, a noncontact IC chip, a small size memory device, or the like may be incorporated therein.

A display device of the present invention can be used for the display portion 982 and a display direction changes as appropriate depending on the usage. Since the camera lens 987 is provided on the same plane as the display portion 982, videophone is possible. Further, still images and motion images can be taken with the camera lens 992 and the light 993 by using the display portion 982 as a viewfinder. The speaker 983 and the microphone 984 can be used for videophone, recording, playback, and the like without being limited to verbal communication. The incoming and outgoing calls, simple input of information such as e-mail, scroll of a screen, cursor motion, and the like can be performed with the operation keys 985. The housings 980 and 981 overlap on each other (FIG. 13A) can slide to be developed as shown in FIG. 13C so as to be used as the portable information terminal. In this case, a smooth operation can be conducted using the keyboard 990 and the pointing device 986. The external connection terminal 988 can be connected to an AC adaptor and a variety of cables such as a USB cable, whereby charging and data communication with a personal computer or the like are possible. Moreover, a recording medium is inserted in the external memory slot 991, so that the cellular phone can handle storage and movement of a larger amount of data.

Further, in addition to the above-described functions, the cellular phone may have an infrared communication function, a television reception function, or the like.

As thus described, the display device of the present invention can be used as the display portion of a variety of electronic appliances as above. With the display device of the present invention used as the display portion, an electronic appliance with a smaller circuit area and low power consumption can be provided.

Note that this embodiment mode can be combined with any of the other embodiment modes as appropriate.

### Embodiment 1

This embodiment describes an example of a display device which performs impulse-type display in accordance with the specification of an actual display device. Note that, as an example, a pixel structure of the display device in this embodiment is the pixel structure shown in FIG. 1 used in Embodiment Mode 1. However, the specification of the display device used in this embodiment is just an example and the present invention is not limited to this.

When the display device of this embodiment employs the pixel structure of Embodiment Mode 1, the capacitance Ca of the capacitor element is approximately 1.3×10⁻¹¹ F. Moreover, in the display device of this embodiment, the resistance r of the resistor element is approximately 2.5×10⁷Ω. In this embodiment, the capacitance Ca of the capacitor element and the resistance r of the resistor element are calculated as follows.

The light emission time necessary for performing impulse-type display which corresponds a CRT display is one horizontal period+τ (τ≧1 msec). Assuming that τ is 1 msec, the capacitance Ca of the capacitor element when τ=1 msec is calculated.

When the display device of this embodiment has a panel size of VGA (640×480 pixels), the pixel electrode has a size of 50×150 μm, and a current of about 0.2 μA flows in the light-emitting element when a voltage of 10 V is applied to the pixel electrode in consideration of the characteristics of the light-emitting element, then the resistance R_{EL} of one light-emitting element is R_{EL}=10 V/(0.2×10⁻⁶ A)=5×10⁷Ω. At this time, Ca is obtained by Formula 1 shown in Embodiment Mode 1: Ca=1×10⁻³ sec/(R_{EL}+r) (this formula is hereinafter called Formula 4).

When current flowing to the light emitting element I_{EL} is 0.2 μA and Va=5 V in Formula 3 shown in Embodiment Mode 1, r=5 V/(0.2×10⁻⁶ A)=2.5×10⁷Ω.

Moreover, when the resistor element in the display device of this embodiment is manufactured using a semiconductor material, the resistance r of the resistor element is represented by r=ρ(l/(w×x)) where ρ is the resistivity of a resistor layer, l is the length of the resistor layer, w is the width of the resistor layer, and x is the film thickness of the resistor layer. For example, if ρ=50 Ωcm, l=10 μm, w=4 μm, and x=50 nm, then the same value as the resistance of the resistor element set above can be obtained: r=2.5×10⁷Ω.

When the R_{EL} and r are substituted into Formula 4, Ca=1×10⁻³ sec/(5×10⁻⁷Ω+2.5×10⁷Ω)=1.3×10⁻¹¹ F.

In order for the capacitor element of the display device of this embodiment to have a capacitance of 1.3×10⁻¹¹ F, an electrode area of about 3.7×10⁻⁹ m² is necessary. The electrode area of the capacitor element in the display device of this embodiment is calculated as follows.

When an insulating layer between electrodes of the capacitor element is a 10-nm-thick SiON film (with a relative dielectric constant of 4), Ca=α₀×ε×S/tox, where ε₀ is the dielectric constant in vacuum, ε is the relative dielectric constant of the insulating layer between the electrodes, and tox is the film thickness of the insulating layer between the electrodes. Based on this formula, the area S is 1.3×10⁻¹¹ F=8.854×10⁻¹² F/m×4×S/(10×10⁻⁹ m); therefore, S=3.7×10⁻⁹ m².

As thus described, with the capacitance of the capacitor element and the electrode area set at the above values in accordance with the specification of the display device in this embodiment, the capacitance necessary for performing impulse-type display can be obtained.

Further, when the capacitance of the capacitor element in the display device of this embodiment is the value obtained by the above formula, the time necessary for accumulating electric charge in the capacitor element when the driver transistor is on is about 0.12 μsec. In the display device of this embodiment, the time necessary for accumulating electric charge in the capacitor element when the driver transistor is on is calculated as follows.

When the frame frequency of the display device of this embodiment is 60 Hz, the driving method is the line sequential drive, and the display device has a panel size of VGA, then one frame period is 1/60 sec≈17 msec. Moreover, one horizontal period is 1/60/480≈35 μsec. In the case of the display device of the present invention, the time for accumulating electric charge in the capacitor element needs to be shorter than one horizontal period. The time for accumulating electric charge in the capacitor element depends on the resistance of the driver transistor.

At this time, the channel resistance Rch of the driver transistor is about 9.5×10³Ω. In the display device of this embodiment, the channel resistance of the driver transistor is calculated as follows.

When the driver transistor operates in a linear region at the time of writing, the channel resistance Rch of the driver transistor is Rch=1/β(Vgs−Vth)(β=(L/W)×μ×Cox) (hereinafter, this formula is referred to as Formula 5), where L is the channel length of the driver transistor, W is the channel width of the driver transistor, μ is the mobility of the driver transistor, and Cox is the gate capacitance per unit area.

When parameters of an n-channel driver transistor using polysilicon for a semiconductor layer are substituted into Formula 5 as an example and L/W=10/10 μm, μ=300 cm²/Vs, Cox=7.4×10⁻⁴ F/m² (corresponding to SiON with a thickness of 50 nm), Vgs=16 V, and Vth=1 V, then the channel resistance of the driver transistor is calculated as 9.5×10³Ω.

The time for accumulating electric charge in the capacitor element, which is obtained from the channel resistance of the driver transistor, is τ=Ca×Rch=1.3×10⁻¹¹ F/m²×9.5×10³Ω=1.2×10⁻⁷ sec=0.12 μsec.

Accordingly, the time for accumulating electric charge in the capacitor element can be 1/100 or less of one horizontal period (about 35 μsec) in the display device of this embodiment, electric charge necessary for performing impulse-type display can be accumulated in the capacitor element within one horizontal period without any problems.

The maximum value of the capacitance of the capacitor element is given from the condition where one horizontal period is equal to the time for accumulating electric charge in the capacitor element in the display device of this embodiment. Based on Formula 2, 35 μsec=Ca×9.5×10³Ω; therefore, the maximum capacitance Ca of the capacitor element is about 3.0×10⁻⁹ F.

As thus described, in consideration of the specification of one display device and the characteristics of transistors as one example, the light emission time necessary for performing impulse-type display which is suitable for motion image display can be obtained by setting the specifications of the capacitor element and the resistor element at the aforementioned values.

This application is based on Japanese Patent Application serial no. 2008-005329 filed with Japan Patent Office on Jan. 15, 2008, the entire contents of which are hereby incorporated by reference.

What is claimed is:

1. A display device comprising:
a scanning line;
a signal line;
a power supply line; and
a pixel,
the pixel comprising:
a resistor element;
a capacitor element including a first terminal and a second terminal;
a first transistor including a gate terminal, a source terminal and a drain terminal, wherein the gate terminal of the first transistor is electrically connected to the scanning line, and one of the source terminal and the drain terminal of the first transistor is electrically connected to the signal line;
a second transistor including a gate terminal, a source terminal and a drain terminal, wherein the gate terminal of the second transistor is electrically connected to the other of the source terminal and the drain terminal of the first transistor, and one of the source terminal and the drain terminal of the second transistor is electrically connected to the power supply line, and the other of the source terminal and the drain terminal of the second transistor is electrically connected to the first terminal of the capacitor element; and
a light-emitting element including a first terminal and a second terminal, wherein the first terminal of the light-emitting element is electrically connected to the first terminal of the capacitor element via the resistor element.

2. A display device comprising:
a scanning line;
a signal line;
a power supply line; and
a pixel,
the pixel comprising:
a resistor element including a first terminal and a second terminal;
a capacitor element including a first terminal and a second terminal;
a first transistor including a gate terminal, a source terminal and a drain terminal, wherein the gate terminal of the first transistor is electrically connected to the scanning line, and one of the source terminal and the drain terminal of the first transistor is electrically connected to the signal line;
a second transistor including a gate terminal, a source terminal and a drain terminal, wherein the gate terminal of the second transistor is electrically connected to the other of the source terminal and the drain terminal of the first transistor, and one of the source terminal and the drain terminal of the second transistor is electrically connected to the power supply line, and the other of the source terminal and the drain terminal of the second transistor is electrically connected to the first terminal of the resistor element;
a third transistor including a gate terminal, a source terminal and a drain terminal, wherein the gate terminal of the third transistor is electrically connected to the other of the source terminal and the drain terminal of the first transistor, one of the source terminal and the drain terminal of the third transistor is electrically connected to the power supply line, and the other of the source terminal and the drain terminal of the third transistor is electrically connected to the first terminal of the capacitor element and the second terminal of the resistor element; and
a light-emitting element including a first terminal and a second terminal, wherein the first terminal of the light-emitting element is electrically connected to the other of the source terminal and the drain terminal of the third transistor and the first terminal of the capacitor element via the resistor element.

3. The display device according to claim 2,
wherein the second transistor and the third transistor have a same conductivity type.

4. A display device comprising:
a scanning line;
a signal line;
a power supply line; and
a pixel,
the pixel comprising:
a resistor element;
a capacitor element including a first terminal and a second terminal;
a transistor including a gate terminal, a source terminal and a drain terminal, wherein the gate terminal of the transistor is electrically connected to the scanning line, and one of the source terminal and the drain terminal of the transistor is electrically connected to the signal line; and
a light-emitting element including a first terminal and a second terminal, wherein the first terminal of the light-emitting element is electrically connected to the first terminal of the capacitor element, and the other of the source terminal and the drain terminal of the transistor via the resistor element.

5. A display device comprising;:
a scanning line;
a signal line;
a power supply line; and
a pixel,
the pixel comprising:
a resistor element including a first terminal and a second terminal;
a capacitor element including a first terminal and a second terminal;
a light-emitting element including a first terminal and a second terminal;
a first transistor including a gate terminal, a source terminal and a drain terminal, wherein the gate terminal of the first transistor is electrically connected to the scanning line, and one of the source terminal and the drain terminal of the first transistor is electrically connected to the signal line;
a second transistor including a gate terminal, a source terminal and a drain terminal, wherein one of the source terminal and the drain terminal of the second transistor is electrically connected to the second terminal of the resistor element, the other of the source terminal and the drain terminal of the second transistor is electrically connected to the second terminal of the capacitor element; and
a third transistor including a gate terminal, a source terminal and a drain terminal, wherein the gate terminal of the third transistor is electrically connected to the other of the source terminal and the drain terminal of the first transistor, the first terminal of the capacitor element, the first terminal of the resistor element, one of the source terminal and the drain terminal of the third transistor is electrically connected to the first terminal of the light-emitting element, and the other of the source terminal and the drain terminal of the third transistor is electrically connected to the power supply line.

6. The display device according to claim 5,
wherein the first transistor and the third transistor have different conductivity types.

7. The display device according to claim 5,
wherein the first transistor and the second transistor have a same conductivity types.

8. The display device according to claim 5, further comprising:
a second scanning line,
wherein the gate terminal of the second transistor is electrically connected to the second scanning line.

9. The display device according to claim 5,
wherein a ground potential is applied to the second terminal of the capacitor element.

10. The display device according to claim 5,
wherein the first to third transistors includes microcrystalline semiconductor layer.

11. The display device according to any one of claims 1, 2, 4 and 5,
wherein a time for accumulating electric charge in the capacitor element is shorter than one horizontal period.

12. The display device according to any one of claims 1, 2, 4 and 5,
wherein the capacitor element includes a first electrode, a second electrode, and a dielectric layer interposed between the first electrode and the second electrode, and
wherein the dielectric layer is formed using a material with a relative dielectric constant of 8 or more.

13. The display device according to any one of claims 1, 2, 4 and 5,
wherein a light emission time of the light-emitting element is shorter than one frame period.

14. The display device according to any one of claims 1, 2, 4 and 5,
wherein a light emission time of the light-emitting element corresponds to a sum of one horizontal period and an electric charge relaxation time of the capacitor element.

15. The display device according to any one of claims 1, 2, 4 and 5,
wherein the resistor element is formed using a semiconductor material.

16. The display device according to any one of claims 1, 2, 4 and 5,
wherein the light-emitting element has a structure in which an electroluminescent layer is provided between two electrodes, and
wherein the electroluminescent layer includes an organic material.

17. The display device according to any one of claims 1, 2, 4 and 5,
wherein the light-emitting element has a structure in which an electroluminescent layer is provided between two electrodes, and
wherein the electroluminescent layer includes an inorganic material such as ZnO, MgₓZ₁₋ₓO, ZnS, ZnTe, or CdS.

18. An electronic appliance having the display device according to any one of claims 1, 2, 4 and 5, wherein the electronic appliance is one selected from cameras such as video cameras and digital cameras, goggle type displays, navigation systems, sound reproducing devices, notebook personal computers, game machines, cellular phones, portable information terminals, image reproducing devices provided with recording media.
